(19) United States
(12) Patent Application Publication
(10) Pub. No.: US 2025/0377266 A1
(43) Pub. Date: Dec. 11, 2025

(54) Automated Sample Block Geometry Detection System

(71) Applicant: Clarapath, Inc., Hawthorne, NJ (US)

(72) Inventors: Partha P. Mitra, New York, NY (US); Robert Chen, Hawthorne, NY (US); Baris Yagci, Montclair, NJ (US); Charles Cantor, Hawthorne, NY (US)

(73) Assignee: Clarapath, Inc., Hawthorne, NJ (US)

(21) Appl. No.: 18/873,045

(22) PCT Filed: Jun. 9, 2023
(86) PCT No.: PCT/US2023/068237

§ 371 Date: Dec. 9, 2024

Related U.S. Application Data
(60) Provisional application No. 63/350,660, filed on Jun. 9, 2022.

(51) Int. Cl. G01N 1/06; B26D 5/00; B26D 7/26; G01B 11/27; G01B 11/30

(52) U.S. Cl. CPC G01N 1/06; B26D 5/007; B26D 7/2628; G01B 11/272; G01B 11/303; G01N 2001/068

(57) ABSTRACT

A system includes a chuck configured to accept a sample block, a blade including a blade surface configured to remove a tissue section from the sample block, where the chuck is moveable relative to the blade surface of the blade, at least one sensor configured to sense a front face of the sample block, and a control system. The control system is configured to receive measurements from the at least one sensor, identify, from the measurements, a geometry of the front face, identify, based on the geometry, an alignment of the front face with respect to the blade surface of the blade, and cause the chuck or the blade to move relative to each other to align the front face relative to the blade surface.

### CROSS-REFERENCE TO RELATED APPLICATION

This application claims the benefit of and priority to U.S. Provisional Patent Application No. 63/350,660, filed Jun. 9, 2022, the contents of which are incorporated herein by reference in their entirety.

### FIELD

The present disclosure relates to automated systems and methods for sectioning tissue from biological sample blocks, and, more particularly, to systems and methods for detecting the geometry of the front face of the sample block to align the front face relative to a blade.

### BACKGROUND

Traditional microtomy, the production of micron-thin tissue sections for microscope viewing, is a delicate, time-consuming manual task. Recent advancements in the digital imaging of tissue sample sections have made it desirable to slice blocks of specimen very quickly. By way of example, where tissues are sectioned as part of clinical care, time is an important variable in improving patient care. Every minute that can be saved during sectioning of tissue for intra-operative applications of anatomic pathology, for example in examining margins of lung cancers to determine whether enough tissue has been removed, is of clinical value. To create a large number of sample sections quickly, it is desirable to automate the process of cutting tissue sections from the supporting sample block by a blade and facilitating the transfer of exposed tissue sections to slides.

Every minute that can be saved during sectioning of tissue for intra-operative applications of anatomic pathology, can be critical. Poor cut quality of the sectioned tissue can slow the process while an operator, or lab worker, is attempting to determine the underlying source of the poor cut quality. It would be advantageous to provide an automated system that can detect an orientation of the sample block to minimize the facing time or to flag a block to be removed from the system.

### SUMMARY

In some embodiments, the present disclosure relates to a system including a chuck configured to accept a sample block, a blade including a blade surface configured to remove a tissue section from the sample block, where the chuck is moveable relative to the blade surface of the blade, at least one sensor configured to sense a front face of the sample block, and a control system. The control system is configured to receive measurements from the at least one sensor, identify, from the measurements, a geometry of the front face, identify, based on the geometry, an alignment of the front face with respect to the blade surface of the blade, and cause the chuck or the blade to move relative to each other to align the front face relative to the blade surface.

In some embodiments, the present disclosure relates a system including at least one sensor configured to sense data regarding an alignment of a front face of a sample block and a blade surface of a blade configured to remove a tissue section from the sample block. The system also includes a controller in communication with the at least one sensor and configured to receive data from the at least one sensor, identify, from the data, a geometry of the front face, identify, based on the geometry, the alignment of the front face with respect to the blade surface of the blade, and cause a chuck holding the sample block or the blade to move relative to each other to align the front face relative to the blade surface.

In some embodiments, the present disclosure relates to a method including sensing, with at least one sensor, data regarding a front face of a sample block, where the sample block is received within a chuck, and where the chuck is moveable relative to a blade surface of a blade configured to remove a tissue section from the sample block. The method further includes sending, by the at least one sensor, the sensed data to a controller, identifying, by the controller and from the sensed data, a geometry of the front face, identifying, by the controller and based on the geometry, an alignment of the front face with respect to the blade surface of the blade, and causing the chuck or the blade to move relative to each other to align the front face relative to the blade surface.

In some embodiments, the present disclosure relates to a method including receiving, by a controller, data sensed with at least one sensor, where the data relates to an alignment of a front face of a sample block received in a chuck and a blade surface of a blade configured to remove a tissue section from the sample block, identifying, by the controller and from the data, a geometry of the front face, identifying, by the controller and based on the geometry, the alignment of the front face with respect to the blade surface of the blade, and causing the chuck or the blade to move relative to each other to align the front face relative to the blade surface.

### BRIEF DESCRIPTION OF DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1A is a side view illustration of a sample system layout in accordance with some embodiments of the present disclosure;

FIG. 1B is a side view illustration of an example sample block in accordance with some embodiments of the present disclosure;

FIG. 1C is a perspective view of the sample block and the blade in accordance with some embodiments of the present disclosure;

FIG. 1D is a perspective view of the sample block and the blade in accordance with some embodiments of the present disclosure;

FIG. 1E is a flow chart illustration of a sample method of operation in accordance with some embodiments of the present disclosure;

FIG. 1F presents an exemplary method for determining geometry of the front face;

FIG. 2A and FIG. 2B are side view illustrations of a single axial sensors for identifying the geometry of the sample block in accordance with some embodiments of the present disclosure;

FIG. 2C and FIG. 2D are side view illustrations of a plurality of axial sensors for identifying the geometry of the sample block in accordance with some embodiments of the present disclosure;

FIGS. 3A-3C is a side view illustration of lateral sensors implementing beams for identifying the geometry of the sample block in accordance with some embodiments of the present disclosure;

FIG. 3D is a side view illustration of lateral sensors implementing a lateral sheet for identifying the geometry of the sample block in accordance with some embodiments of the present disclosure;

FIG. 4A is a front view illustration of cameras for identifying the geometry of the sample block in accordance with some embodiments of the present disclosure;

FIG. 4B is a side view illustration of cameras for identifying the geometry of the sample block in accordance with some embodiments of the present disclosure;

FIG. 5 is a front view illustration of a laser grid for identifying the geometry of the sample block in accordance with some embodiments of the present disclosure;

FIG. 6A is a side view illustration of using motor current to identify the geometry of the sample block in accordance with some embodiments of the present disclosure;

FIG. 6B is a graph illustrating position relative to the motor current;

FIG. 7A is a side view illustration of using a load cell to identify the geometry of the sample block in accordance with some embodiments of the present disclosure;

FIG. 7B is a graph illustrating position relative to the force;

FIG. 8A is a side view illustration of identifying electric contact to identify the geometry of the sample block in accordance with some embodiments of the present disclosure;

FIG. 8B is a graph illustrating position relative to the contact current;

FIG. 9A is an above view illustration of a sample system layout in accordance with some embodiments of the present disclosure;

FIG. 9B and FIG. 9C are isometric view illustrations of a sample system layout in accordance with some embodiments of the present disclosure;

FIG. 9D is a top view illustration of a sample system layout in accordance with some embodiments of the present disclosure;

FIG. 10 is a block diagram illustrating a control feedback loop; and

FIG. 11 is an exemplary high-level architecture for implementing processes in accordance with the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure relates to a system including: a chuck configured to accept a sample block; a blade including a blade surface configured to face the sample block, wherein the chuck is moveable relative to the blade surface of the blade; at least one stationary sensor configured to sense a front face of the sample block; and a control system configured to: receive measurements from the at least one stationary sensor; identify, from the measurements, a geometry of the front face; identify, based on the geometry, an alignment of the front face with respect to the blade surface of the blade; and cause the chuck or the blade to move relative to each other to align the front face relative to the blade surface and to section the sample block to facilitate sectioning of the tissue block.

In some embodiments, the present disclosure relates to a system, wherein the chuck is configured to move along a first degree of freedom and a second degree of freedom, wherein the first degree of freedom is along an X axis to align the front face relative to the blade surface and the second degree of freedom is along an Z axis to enable the blade to section the sample block. In some embodiments, the present disclosure relates to a system, wherein the blade and the sensor are stationary relative to one another. In some embodiments, the present disclosure relates to a system wherein identifying the geometry includes identifying, from the measurements, an orientation of the front face relative to the blade surface. In some embodiments, the present disclosure relates to a system, wherein identifying the geometry includes identifying, from the measurements, a topography of the front face. In some embodiments, the present disclosure relates to a system, wherein the at least one stationary sensor is an axial sensor configured to sense a distance between the axial sensor and the front face at a plurality of positions of the sample block. In some embodiments, the present disclosure relates to a system, wherein the at least one stationary sensor is a plurality of axial sensors configured to sense a distance to the front face. In some embodiments, the present disclosure relates to a system, wherein the at least one stationary sensor is a lateral sensor configured to sense an intersection between a signal generated by the lateral sensor and the front face at a plurality of positions of the sample block. In some embodiments, the present disclosure relates to a system, wherein the at least one stationary sensor is a plurality of lateral sensors configured to each sense an intersection between a signal generated by a respective lateral sensor and the front face. In some embodiments, the present disclosure relates to a system, wherein the at least one stationary sensor is a plurality of cameras configured to each capture one or more images of the front face. In some embodiments, the present disclosure relates to a system, wherein the at least one stationary sensor is a plurality of sensors configured to generate a measurement grid and detect a plurality of intersections between the measurement grid and the front face. In some embodiments, the present disclosure relates to a system, wherein the at least one stationary sensor is a position sensor and a motor sensor, the position sensor configured to identify a plurality of positions of the chuck holding the sample block, the motor sensor configured to identify power usage of a motor moving the chuck at each of the plurality of positions. In some embodiments, the present disclosure relates to a system, wherein the at least one stationary sensor is a position sensor and a force sensor, the position sensor configured to identify a plurality of positions of the chuck holding the sample block, the force sensor configured to identify a force between the front surface and the blade surface at each of the plurality of positions. In some embodiments, the present disclosure relates to a system, wherein the at least one stationary sensor is a position sensor and a conductivity sensor, the position sensor configured to identify a plurality of positions of the chuck holding the sample block, the conductivity sensor configured to identify conductivity at the blade surface at each of the plurality of positions of the chuck holding the sample block.

In some embodiments, a microtomy system includes a chuck configured to accept a sample block. In some embodiments, the microtomy system includes a blade including a blade surface configured to face the sample block, wherein the chuck is moveable relative to the blade surface of the blade. In some embodiments, a microtomy system includes at least one stationary sensor configured to sense a front face of the sample block. In some embodiments, a microtomy system includes a control system. The control system can receive measurements from the at least one sensor. The control system can identify, from the measurements, an orientation of the front face with respect to the blade surface of the blade. The control system can cause the chuck or blade to move relative to each other to align the front face relative to the blade surface.

The present disclosure relates to processing sample blocks with biological tissue samples that can be embedded in paraffin for preservation. A blade surface of a blade can be used to cut a front face of a sample block to face the sample block to expose the tissue sample in the sample block (also referred to as facing) and then to section the tissue sample. The blade can be designed to cut thin sections along the front face of the block. The sections of tissue can be transferred to a transfer/transport medium such as tape and then, by the transfer medium to slides for pathology or histology examination.

However, the front face of the block can have a unique geometry, including one or both of orientation (e.g., parallel or not parallel with the blade surface) and topography (e.g., smooth or bumpy) of the front face. For example, the orientation of the front face can be parallel to the blade surface. In contrast, the front face can be tilted or twisted relative to the blade surface. In another example, the topography of the front face is smooth. In contrast, the topography of the front face can include protrusions or bulges. The geometry of the front face of the tissue block relative the blade surface can be described as an alignment.

If the orientation or the topography of the front face is not optimized, then the front face of the tissue block and the blade surface can be misaligned. When misaligned, the blade might cut a slice of material that is thicker than intended. Such cuts can cause the blade to exert high torque on the sample block or otherwise damage the sample block or tissue sample, which can cause the sample block to fall out of the chuck or the tissue sample to become damaged or dislodged within the sample block. If the orientation of the front face of the tissue block is not parallel with the blade surface, the orientation of the front face can be described as not optimized. If the topography of the front face of the tissue block features protrusions and bulges of certain dimensions, the topography of the front face can be described as not optimized.

If the orientation or the topography of the front face is optimized, then the front face of the tissue block and the blade surface can be aligned. When aligned, the blade can cut a slice of material that is an intended and desired thickness and can include a tissue sample of desired thickness. Such cuts can cause the blade to exert a controlled torque (i.e. no or minimal torque) on the sample block. When aligned, the cut may not damage the sample block or tissue sample, cause the sample block to fall out of the chuck, or cause the tissue sample to become damaged or dislodged within the sample block. If the orientation of the front face of the tissue block is parallel with the blade surface, the orientation of the front face can be described as optimized. If the topography of the front face of the tissue block is substantially flat or smooth, the topography of the front face can be described as optimized.

To address this problem and to facilitate sectioning of the sample block within desired parameters, the methods and systems of the present disclosure can detect the geometry of the front face of the sample block to ensure that the sample block is aligned relative to the blade to enable the blade to efficiently face the sample block and to section the tissue sample. In some embodiments, the chuck can maneuver (e.g., twist or tilt) the sample block to align (e.g., make parallel or adjust the distance between the blade surface and a protrusion of the sample block) the front face with the blade surface. In some embodiments, the chuck can move (e.g., along the X axis) the sample block to adjust the distance between the blade surface and the tip of a protrusion on the front face of the sample block to cause the blade to gently shave small pieces of the tip of the protrusion on the front face (e.g., decrease the thickness of the cuts) to facilitate sectioning of the sample block, while preventing too much torque on the sample block or the tissue inside the sample block.

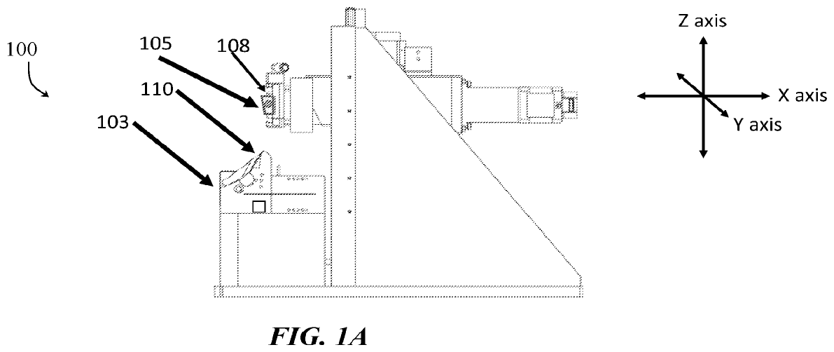

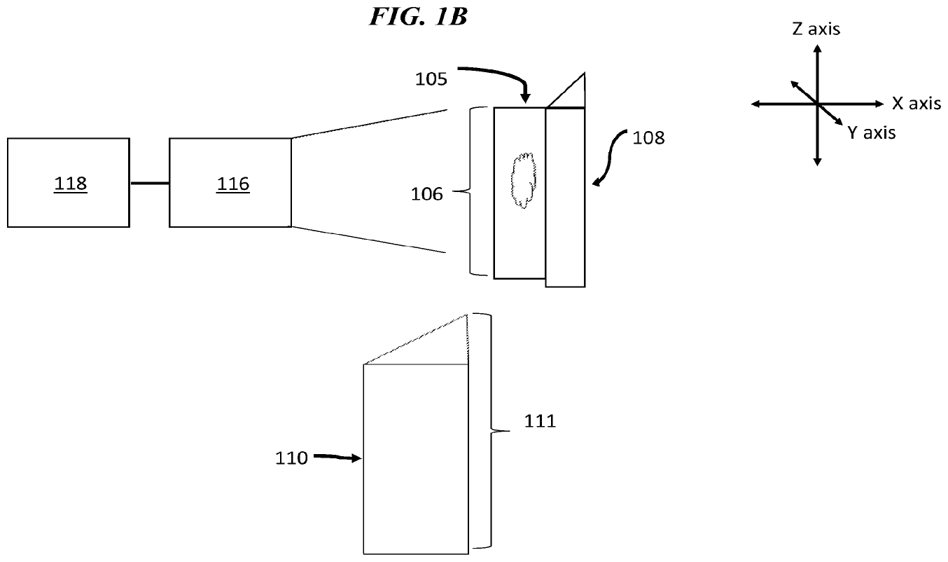

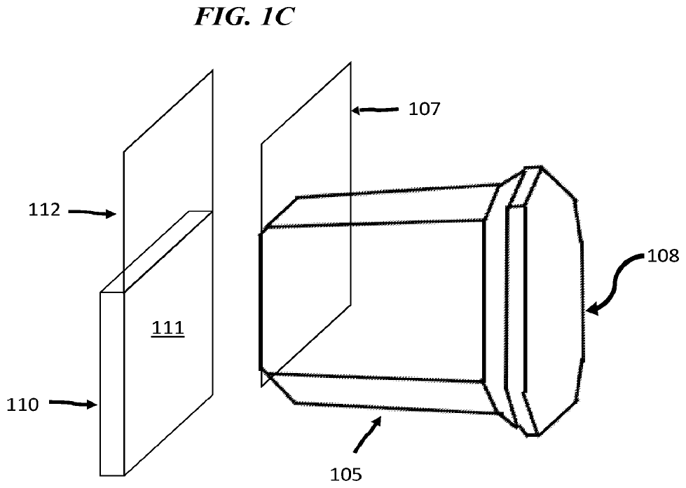

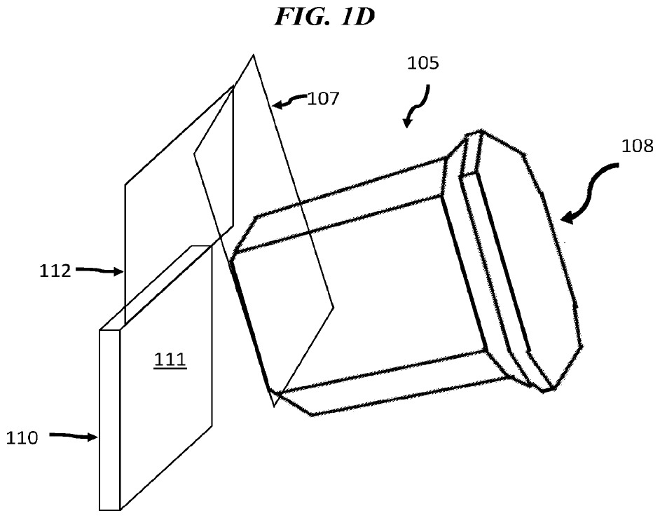

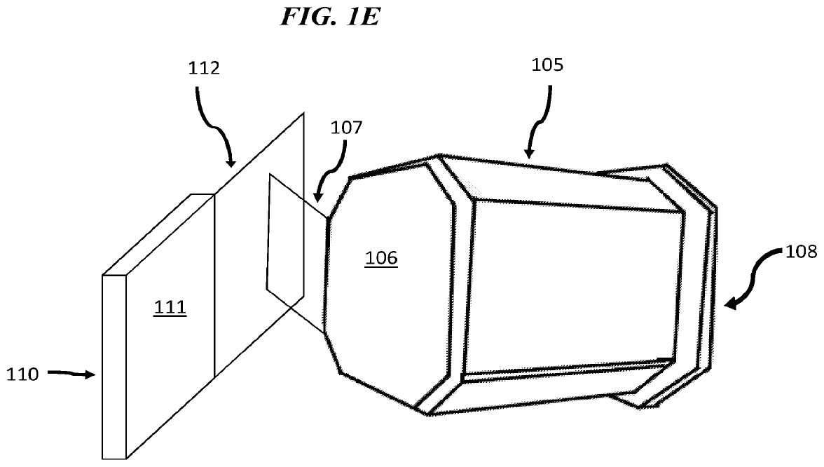

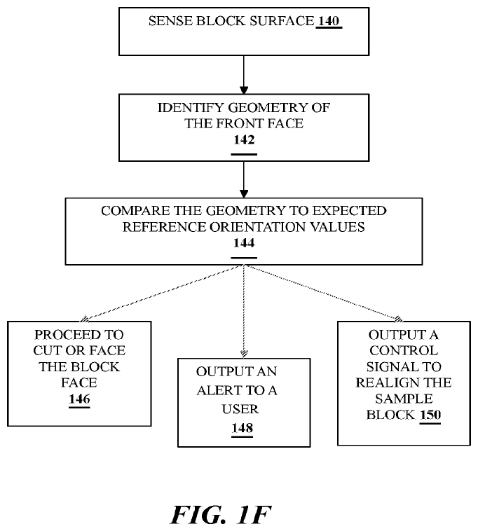

In some embodiments, as shown in FIGS. 1A-1E, the present disclosure provides a system 100 that can be used for efficiently processing sample blocks 105 including biological tissue samples embedded in paraffin. In some embodiments, the system 100 may include a microtome assembly 103 having one or more blades 110, a chuck 108 for holding the sample block 105 and being moveable relative to the microtome assembly 103, and a surface sensor 116 configured to generate measurements of the front face 106 of the sample block 105. The system may also include a controller 118 in communication with the surface sensor 116 to receive the measurements of the sample block 105.

As shown in FIGS. 1C-IE, since the blade surface 111 can be configured to section the front face 106 of the sample block 105 along the Z axis, the quality of the cuts can be optimal when the blade plane 112 of the blade surface 111 and the face plane 107 of the front face 106 are parallel with respect to each other. In some embodiments, the blade 110 is stationary and the chuck 108 moves the sample block 105 towards the blade 110 until the front face 106 is faced by the blade surface 111. For example, the chuck 108 can move along the X axis towards the blade surface 111 until the blade surface 111 is positioned a desired distance from the front face 106 (indicating a desired cut thickness), and the chuck 108 can move the front face 106 along the Z axis and against the blade surface 111 for the blade surface 111 to face the front face 106 along the Z axis. In some embodiments, the blade 110 moves towards the sample block 105 until the blade surface 111 faces the front face 106. For example, the blade 110 can move along the X axis towards the front face 106 until the blade surface 111 is positioned a desired distance from the front face 106 (indicating a desired cut thickness), and then the blade 110 can move up and down along the Z axis such that the blade surface 111 faces the front face 106. If the face plane 107 is not parallel with the blade plane 112, then the sample block 105 or the tissue sample may be damaged. For example, as shown in FIG. 1D, the sample block 105 and the front face 106 might be tilted about the Y axis with respect to the Z axis. In another example, as shown in FIG. 1E, the sample block 105 and the front face 106 might be twisted about the Z axis with respect to the Y axis. In such cases, the blade 110 may cut more material from the sample block 105 than it is configured for, resulting in a higher torque on or damage to the sample block 105 or tissue sample.

The systems and methods of the present disclosure can quickly and effectively identify the geometry of the front face 106 of the sample block 105 to align the front face 106 with respect to the blade surface 111 of the blade 110. The surface sensor 116 can be configured to generate measurements indicative of the geometry of the front face 106 with respect to the blade surface 111. In some embodiments, the controller 118 may be configured to identify, based on the measurements, the geometry of the front face 106. In some embodiments, identifying the geometry includes the controller 118 identifying the face plane 107 of the front face 106 to identify the orientation of the front face 106 relative to the blade surface 111. If the face plane 107 is optimized (e.g., parallel) with the blade plane 112, then the blade surface 111 of the blade 110 can cut a section the front face 106 of the sample block 105. If the face plane 107 is not optimized (e.g., not parallel) to the blade plane 112, the sample block 105 can be flagged for removal or realigned such that the face plane 107 is oriented with the blade plane 112.

In some embodiments, identifying the geometry includes the controller 118 identifying whether there are protrusions on the front face 106 to identify the topography of the front face 106. If the topography is smooth, then the blade surface 111 of the blade 110 can cut the front face 106 of the sample block 105. If the topography includes protrusions, bumps, or bulges, the sample block 105 can be flagged for removal or re-positioned relative to the blade surface 111. For example, the chuck 108 can position the sample block 105 and thus the front face 106 with the blade surface 111 such that the blade surface 111 can gently shave small pieces of the bumps on the front face 106 to align the front face 106 of sample block 105 with the blade surface 111 to prevent too much torque on the sample block 105 or the tissue inside.

In some embodiments, the controller 118 selects whether to flag or remove the sample block 105 by identifying whether a difference between the face plane 107 and the blade plane 112 satisfies a preset value. If the difference satisfies the preset value (e.g., minor bumps or slight misorientation of the blade surface 111 and the front face 106, such that there is slight misalignment of the front face 106 and the blade surface 111), then the controller 118 selects to align the sample block 105. If the difference fails to satisfy the preset value (e.g., large bulges or major misorientation of the blade surface 111 and the front face 106, such that there is major misalignment of the front face 106 and the blade surface 111), then the controller 118 selects to flag the sample block 105 for removal.

The systems and methods described herein can use optics, sound, and other methods to determine the geometry of the front face 106 of the sample block 105 in the chuck 108. The present disclosure further provides methods and systems for enhanced identification of the geometry of the front face 106 of the sample block 105 based on, for example, lasers, ultrasonic pulses, images, current, and force. In some embodiments, one or more surface sensors 116 may be used that can monitor the position or geometry of the front face 106 of the sample block 105 or the position of the blade 110 or the chuck 108 holding the sample block 105. In some embodiments, the surface sensors 116 can be located on the microtome assembly 103, or sensors monitoring the microtome assembly 103 itself. In some embodiments, the surface sensors 116 may be alternatively, or additionally, located on the chuck 108 holding the sample block 105.

In some embodiments, the surface sensor 116 is stationary. That is, the one or more surface sensors 116 are not required to be moved or rotated in order to sense the geometry of the front face 106 of the sample block 105 to identify the geometry of the front face 106. In some embodiments, the surface sensor 116 is fixed to the microtome assembly 103 at a reference point with respect the sample block 105. In some embodiments, the geometry of the front face 106 of the sample block 105 can be identified based on calculation of the angle between the front face 106 of the sample block 105 and the blade surface 111 of the blade 110 using various measurement techniques. The geometry can be used to flag the sample block 105 to be removed or to align the front face 106 of the sample block 105 with the blade surface 111 to minimize the facing time. In some embodiments, the surface sensor 116 is movable. In some embodiments, the surface sensor 116 is movable relative the front face 106 of the sample block 105.

In some embodiments, as shown in FIG. 1A, the system 100 can be used to facilitate efficient processing of the sample blocks 105 including biological samples, such as tissue, embedded in paraffin. In particular, as is discussed in more detail below, the system 100 is designed to accept one or more sample blocks 105 on a chuck 108. Each sample block 105 comprises a tissue sample embedded in an embedding or preservation material. The sample blocks 105 are delivered to a microtome assembly 103 having one or more blades 110 (e.g., cutting tool, cutter, or any other device configured to face or cut). The one or more sample blocks 105 are “faced” using one or more blades 110 of the microtome assembly 103 by removing one or more layers of the preservation material in which the tissue is embedded to expose a large cross section of the tissue sample. Next, one or more tissue sections comprising a sample of tissue can be sliced or sectioned from the sample block 105, using one or more blades 110. The sections of the tissue sample are transferred, for example, using automated transfer medium, to slides for further processing.

In some embodiments, as shown in FIGS. 1A-1E, the chuck 108 can be configured to move the sample block 105 towards the blade 110 along the X axis. In some embodiments, the sample block 105 is aligned with the blade 110 to eliminate the gap between the sample block and the blade, while accounting for the unique geometry of the sample block being sectioned. In some embodiments, the chuck 108 can be configured to maneuver the sample block 105 along the Y and Z axes. In some embodiments, the blade surface 111 of the blade 110 can be configured to section the front face 106 of the sample block 105 along the Z axis to expose the tissue inside the sample block 105, and the surface sensors 116 can be configured to sense the front face 106 along the X, Y, or Z axes.

In some embodiments, identifying the geometry includes the controller 118 identifying the face plane 107 of the front face 106 to compare to the blade plane 112 to identify the orientation of the front face 106 with respect to the blade surface 111. The face plane 107 can define the orientation of the front face 106 with respect to the Y and Z axes. In some embodiments, the face plane 107 can be defined by a Y dimension and a Z dimension. In some embodiments, the face plane 107 can include a Y dimension in the direction of the Y axis. In some embodiments, the face plane 107 can include a Z dimension in the direction of the Z axis. The blade plane 112 can define the orientation of the blade surface 111 with respect to the Y and Z axes. By sectioning the front face 106 of the sample block 105, the blade surface 111 can remove the preservation material in which the tissue is embedded to expose a large cross section of the tissue sample and then section the tissue sample.

In some embodiments, because the blade surface 111 can be configured to section the front face 106 of the sample block 105 along the Z axis, the quality of the cuts can be improved by identifying that the blade plane 112 of the blade surface 111 and the face plane 107 of the front face 106 are parallel with respect to each other. If the face plane 107 is not properly aligned with the blade plane 112, such that the two are parallel, then the blade surface 111 might make uneven cuts of the sample block 105, which can reduce or degrade cut quality or even dislodge the sample block 105 from the chuck 108 or the tissue sample from the sample block 105. For example, as shown in FIG. 1D, the sample block 105 might be tilted about the Y axis with respect to the Z axis. In another example, as shown in FIG. 1E, the sample block 105 might be twisted about the Z axis with respect to the Y axis. If the sample block 105 is tilted or twisted, then the front face 106 would not be parallel, or aligned, with the blade surface 111, which might cause the blade 110 to only cut the edge of the sample block 105 or cut out (i.e. dislodge) the tissue inside the sample block 105.

To address this problem, the system 100 can include the surface sensor 116 configured to generate measurements indicative of the alignment of the front face 106 with respect to the blade surface 111. The controller 118 can use the measurements to identify whether the face plane 107 is parallel to the blade plane 112. If the controller 118 identifies that the face plane 107 is parallel to the blade plane 112, then the controller 118 can cause the blade surface 111 of the blade 110 to section the front face 106 of the sample block 105. If the front face 106 is tilted or twisted, the controller 118 can flag the sample block 105 for removal or cause the chuck 108 to align the sample block 105 such that the front face 106 is parallel with the blade surface 111 of the blade 110. In some embodiments, the controller 118 selects whether to flag or remove the sample block 105 by identifying whether a difference between the face plane 107 and the blade plane 112 satisfies a preset value. If the difference satisfies the preset value (e.g., slight misorientation of the blade surface 111 and the front face 106, such that there is slight misalignment of the front face 106 and the blade surface 111), then the controller 118 selects to align the sample block 105. If the difference fails to satisfy the preset value (e.g., major misorientation of the blade surface 111 and the front face 106, such that there is major misalignment of the front face 106 and the blade surface 111), then the controller 118 selects to flag the sample block 105 for removal.

In some embodiments, the surface sensor 116 can be one or more sensors configured to sense the face plane 107. In some embodiments, the surface sensor 116 can be laser sensors, ultrasonic sensors, optical sensors, cameras, load cells, electric sensors, photo sensors, video sensors, highspeed image sensors, strain gauges, microphones, acoustic sensors or similar sensors that can be configured to identify or detect the face plane 107 relative to the blade plane 112 or other structures in the system 100.

In some embodiments, the surface sensor 116 can be one or more axial laser sensors configured to generate one or more laser beams towards the front face 106 to measure the distance between the one or more axial laser sensors and the front face 106. In some embodiments, the surface sensor 116 can be one or more axial ultrasonic sensors configured to generate one or more ultrasonic pulses towards the front face 106 to measure the distance between the one or more axial ultrasonic sensors and the front face 106. In some embodiments, the surface sensor 116 can be one or more lateral laser sensors configured to generate one or more laser beams towards the front face 106. In some embodiments, if the controller 118 identifies that the intersections with the laser beams occur along a curve, then the controller 118 can identify that the front face 106 is bumpy or not parallel with the blade surface 111. In some embodiments, the surface sensor 116 can be a top camera and a side camera configured to generate one or more images of the front face 106. For example, if an image of the tissue cameras shows bumps, bulges, or indents, the controller 118 can determine that the front face 106 should be realigned with the blade surface 111. In some embodiments, the surface sensor 116 can be a plurality of sensors configured to generate a laser grid to detect intersections of the front face 106 with the laser grid. In some embodiments, the surface sensor 116 can be an electric sensor configured to identify a motor current drawn by a motor operating the blade 110 to cut the front face 106. In some embodiments, the surface sensor 116 can be a force sensor configured to identify a force applied by the blade 110 to the front face 106. In some embodiments, the surface sensor 116 can be an electric sensor to identify electric contact between the blade 110 and the sample block 105. In some embodiments, if the surface sensor 116 identifies increased forces or higher current, the controller 118 can determine that the front face 106 is not aligned with the blade surface 111.

FIG. 1F presents an exemplary method for determining geometry of the front face 106 to identify whether the front face 106 is aligned with the blade surface 111. In some embodiments, the system 100 can include the controller 118 configured to cause the surface sensor 116 to generate measurements indicative of the geometry of the front face 106, in step 140. In some embodiments, the controller 118 can be configured to receive measurements of the front face 106 based on sensor readings from one sensor or a combination of the sensors described herein.

In step 142, the controller 118 can use the information received from the surface sensor about the front face 106 to identify the geometry of the front face 106. In some embodiments, the controller 118 can be configured to use the measurements from the surface sensor 116 to identify or calculate the face plane 107. In some embodiments, the controller 118 can be configured to use the measurements from the surface sensor 116 to identify or calculate the orientation of the face plane 107 or the front face 106. In some embodiments, the controller 118 can be configured to identify the topography of the front face 106. In some embodiments, the controller 118 can be configured to identify any protrusions on the front face 106. In some embodiments, as described in further detail below, the controller 118 can identify the geometry of the front face 106 based on intersections with a laser grid and forces identified by a load cell. In some embodiments, the controller 118 can accomplish these identifications without human intervention.

In some embodiments, the controller 118 can cause the surface sensor 116 to generate sensor measurements of the blade 110 or the blade surface 111. The controller 118 can use the sensor measurements to identify the blade plane 112. In some embodiments, the controller 118 can be configured to identify the blade plane 112 by identifying the position of the blade 110 as it moves. In some embodiments, the controller 118 can identify or maintain a position (e.g., x, y, z coordinates) of the surface sensor 116 relative to the blade 110. In some embodiments, the surface sensor 116 is in a fixed position so that the controller 118 can identify the orientation of the face plane 107 relative to the blade plane 112. The controller 118 can use the position of the surface sensor 116 to identify the blade plane 112. In some embodiments, the blade plane 112 is known to the controller 118. For example, the blade 110 can be positioned such that the blade surface 111 and its blade plane 112 is parallel to the Z axis. In some embodiments, the controller 118 can be configured to retrieve, from memory, the blade plane 112.

In step 144, the controller 118 can analyze the geometry of the front face 106. In some embodiments, analyzing the geometry includes the controller 118 determining the alignment of the front face 106 relative the blade surface 111. Determining the alignment of the front face 106 can include analyzing the geometry of the front face 106 relative the blade surface 111. In some embodiments, analyzing the geometry, or determining the alignment, includes the controller 118 identifying the orientation the front face 106 relative to the blade surface 111. In some embodiments, analyzing the geometry, or determining the alignment, includes the controller 118 identifying the topography of the front face 106. In some embodiments, the controller 118 can include an algorithm that may use data from one or more of the sensor outputs to reach a conclusion about the geometry of the front face 106, the alignment of the front face 106 with the blade surface 111, and cut quality prediction. The control algorithm can determine that the geometry of the front face 106, or the alignment of the front face 106 with the blade surface 111, exceeds a predetermined value outside a pre-determined threshold, or is within nominal or not-nominal ranges. The algorithm can use a decision tree to conclude the geometry of the front face 106, or the alignment of the front face 106 with the blade surface, is within or without pre-determined ranges based on data from the one or more measurements of the surface sensor 116. In some embodiments, the algorithm can accomplish these determinations without human intervention.

In some embodiments, in step 146, if the controller 118 identifies that the front face 106 is aligned with the blade surface 111, the controller 118 can cause the blade surface 111 of the blade 110 to face or section the front face 106. In some embodiments, if the controller 118 identifies that the face plane 107 is parallel with the blade plane 112, the controller 118 can cause the blade surface 111 of the blade 110 to face or section the front face 106. In some embodiments, if the controller 118 identifies that the front face 106 is smooth, the controller 118 can cause the chuck 108 to move the front face 106 down towards the blade surface 111 to face or section the sample block 105. For example, the chuck 108 can move the front face 106 along the Z axis and against the blade surface 111 for the blade surface 111 to face or section the front face 106 along the Z axis. In some embodiments, if the controller 118 identifies that the front face 106 is smooth or parallel with the blade surface 111, the controller 118 can cause the blade surface 111 of the blade 110 to face or section the front face 106. For example, the blade surface 111 can section the front face 106 along the Z axis. In some embodiments, the controller 118 can determine the front face 106 is aligned with the blade surface 111 if the determined alignment of the front face 106, or the geometry of the front face 106 relative the blade surface 111, is under a pre-determined threshold value or is within nominal ranges, for instance.

In some embodiments, in step 148, if the controller 118 identifies that the front face 106 is misaligned with the blade surface 111, the controller can output an alert to a user for the user to manual adjust the sample block 105 (i.e. align the front face 106 with the blade surface 111) or remove the sample block 105. In some embodiments, if the controller 118 identifies that the face plane 107 is not properly aligned with the blade plane 112, the controller 118 can output an alert to a user for manual adjustment (i.e. alignment) of the sample block 105 or removal of the sample block 105. In some embodiments, if the controller 118 identifies that the front face 106 is not parallel with the blade surface 111, the controller 118 can output an alert to a user for manual adjustment (i.e. alignment) of the sample block 105 or removal of the sample block 105. In some embodiments, the surface sensor 116 or controller 118 can use the orientation of the front face 106 to create an alert when the orientation is out of an allowed range or exceeds a pre-determined threshold value. In some embodiments, if the controller 118 identifies that the front face 106 is not smooth, the controller 118 can output an alert to a user for manual adjustment (i.e. alignment) of the sample block 105 or removal of the sample block 105. In some embodiments, the surface sensor 116 or controller 118 can use the topography of the front face 106 to create an alert when the topography is out of an allowed range or exceeds a pre-determined threshold value. In some embodiments, if the controller 118 identifies that the front face 106 is not smooth or not parallel with the blade surface 111, the controller 118 can output an alert to a user.

In some embodiments, in step 150, if the controller 118 identifies that the front face 106 is not aligned with the blade surface 111, the controller 118 can send an output control signal to the chuck 108 to re-position the sample block 105 such that the front face 106 is aligned with the blade surface 111. In some embodiments, if the controller 118 identifies that the front face 106 is not aligned with the blade surface 111, and particularly that the front face 106 is not parallel with the blade surface 111, the controller can send an output control signal to the chuck 108 to move and align the sample block 105 with the blade surface 111 such that the front face 106 is parallel with the blade surface 111 (and the controller 118 can optionally notify a user of the change). In some embodiments, the controller 118 can use the orientation of the front face 106 to output a control signal when the orientation is out of an allowed range or exceeds a pre-determined threshold value. In some embodiments, if the controller 118 identifies that the front face 106 is not smooth, the controller 118 can send an output control signal to the chuck 108 to move the front face 106 relative to the blade surface 111, and optionally, notify a user of such change. In some embodiments, the chuck 108 can move the sample block 105 (e.g., towards or away from the blade 110 along the X or Z axis) to adjust the distance between the blade surface 111 and any protrusions on the front face 106 and cause the blade 110 to gently shave small pieces of the tip of the protrusion (e.g., decrease the thickness of the cuts) on the front face 106 to smooth the front face 106 and align the front face 106 with the blade surface 111. In some embodiments, the controller 118 can use the topography of the front face 106 to output a control signal when the topography is out of an allowed range or exceeds a pre-determined threshold value. Aligning the front face 106 with the blade surface 11 (either manually in step 148 or automatically with control signals in step 160) can prevent damage on the sample block 105 or the tissue inside the sample block 105. The controller 118 can use the geometry of the front face 106 for downstream actuation or control over the sample block 105 and the blade 110 to improve the quality of the cuts. In some embodiments, if the controller 118 identifies that the front face 106 is not smooth or not parallel with the blade surface 111, the controller 118 can output a control signal to re-position the tissue block 105 or shave the front face 106 of the tissue block such that the front face 106 is aligned (e.g. parallel or smooth) with the blade surface 111.

In some embodiments, the chuck 108 may be/moveable in multiple directions (multiple degree of freedom) to change the orientation of the sample block 105 to properly align the front face 106 with the blade surface 111, as well as along the X axis or Z axis. In some embodiments, the chuck 108 may only have a single degree of freedom. To simplify the system, the chuck 108 may only be able to move along the X axis toward and away from the blade 110. In some embodiments, the chuck 108 may have two degrees of freedom. For example, in some embodiments, the chuck 108 can move the sample block 105 along the X axis to position the face plane 107 in a desired location relative to the blade 110. In addition, the chuck 108 can also move the sample block 105 up and down along the Z axis to enable the blade 110 to section the sample block 105. In some embodiments, the chuck 108 can have three degrees of freedom. For example, in some embodiments, the chuck 108 can move along the X and Z axes as discussed herein, and also move the sample block 105 side to side along the Y axis to enable the blade 110 to section the sample block 105.

In such embodiments, if the front face 106 of the sample block 105 is not properly aligned with the blade surface 111, the chuck 108 may move the sample block 105 to a position to minimize the torque on the sample block 105 or tissue sample, aligning the front face 106 with the blade surface 111. The blade surface 111 can then move along the Z axis to make thin cuts into the sample block 105 (e.g., decrease the thickness of the cuts). In some embodiments, the chuck 108 can keep moving the sample block 105 a predetermined distance toward the blade surface 111 until the front face 106 of the sample block 105 is sufficiently aligned with the blade surface 111 so the blade surface 111 can cut sections of desired size and shape.

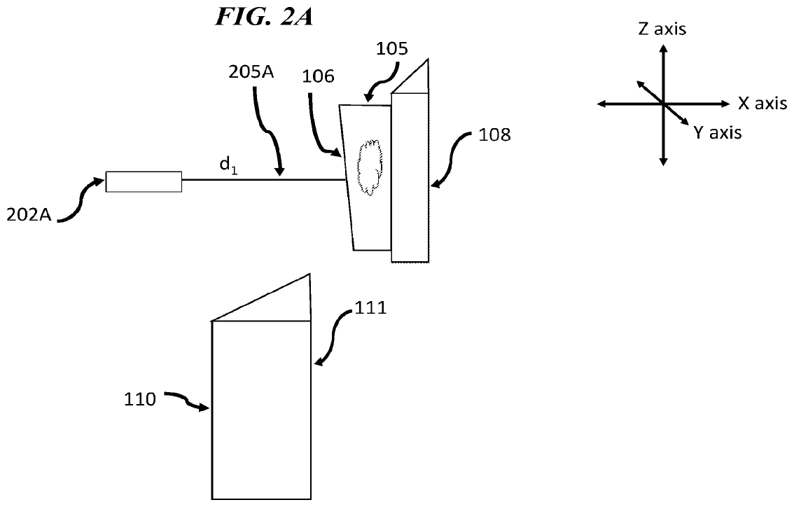

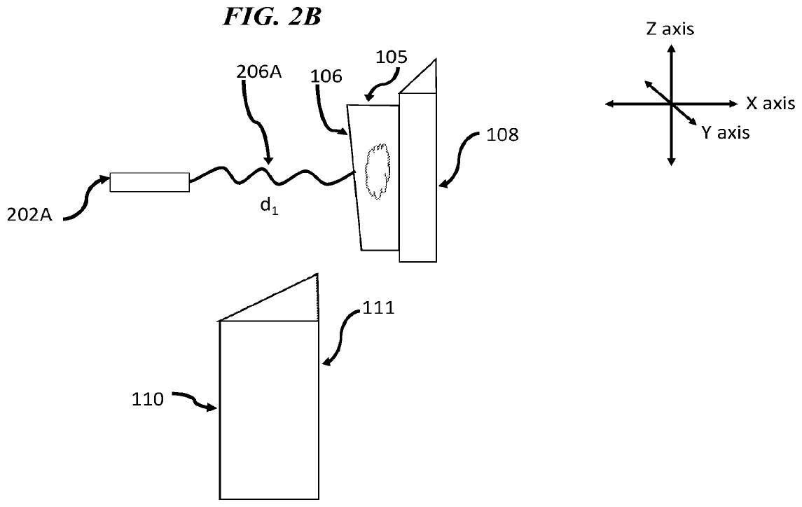

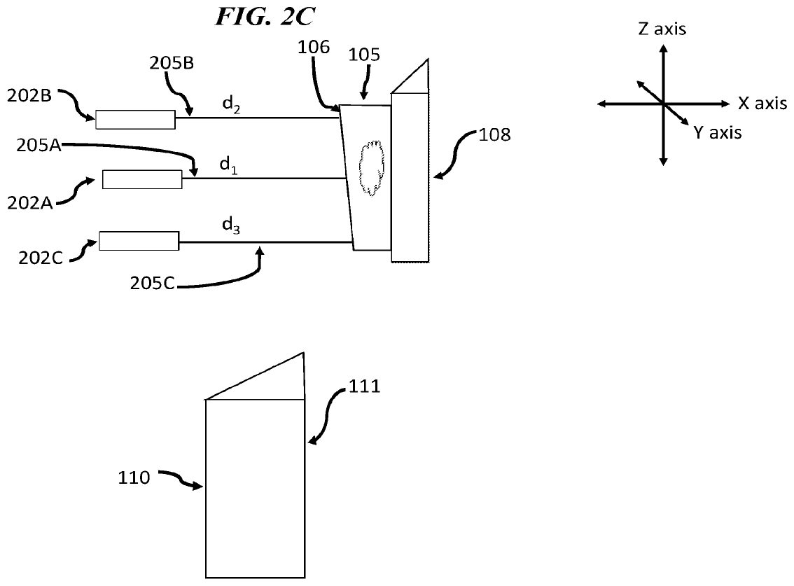

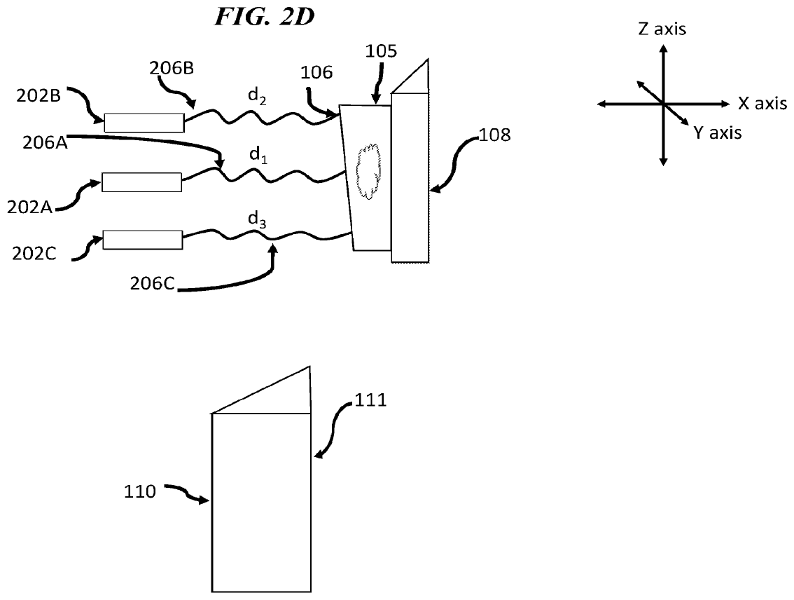

Now referring generally to FIGS. 2A-2D, in some embodiments, the surface sensor 116 can include one or more axial sensors 202A-202C positioned in front of the front face 106. The one or more axial sensors 202A-202C can be configured to measure a plurality of distances (for example, d₁, d₂, d₃) between the axial sensors 202A-202C and various points on the front face 106 (for example, points along the Z axis). The controller 118 can then compare the distances to identify the face plane 107 for comparison to the blade plane 112 and to identify whether the front face 106 is parallel relative to the blade surface 111. For example, if the face plane 107 is parallel to the blade plane 112, then d₁, d₂, d₃ would be expected to be equal. On the other hand, if one or more of d₁, d₂, d₃ are not the same, the face plane 107 is not parallel to the blade plane 112. In some embodiments, the controller 118 can use the distances to detect the topography of the front face 106 to identify whether the front face 106 is smooth. For example, if the front face 106 is smooth, then d₁, d₂, d₃ would be expected to be equal. In another example, if one or more of d₁, d₂, d₃ are not the same, the front face 106 includes protrusions.

In some embodiments, as shown in FIG. 2A, there is provided a single axial sensor 202A that can be configured to measure the distance to the front face 106 by generating a laser beam 205A directed at the front face 106. In some embodiments, as shown in FIG. 2B, the axial sensor 202B can be configured to measure the distance to the front face 106 by generating ultrasonic pulses 206A directed at the front face 106. Now referring generally to FIGS. 2A and 2B, in some embodiments, the controller 118 can cause the axial sensor 202A to generate the laser beam 205A or the ultrasonic pulses 206A. In some embodiments, the controller 118 can cause the axial sensor 202A to generate the laser beam 205A or the ultrasonic pulses 206A as the chuck 108 holding the sample block 105 moves by a known distance along the Y, or Z axes in front of the axial sensor 202A for the surface sensor to measure a distance to multiple locations on the front face 106 of the sample block 105. In some embodiments, the controller 118 can cause the axial sensor 202A to generate the laser beam 205A or the ultrasonic pulses 206A as the chuck 108 moves along the X axis. In some embodiments, the controller 118 can cause the axial sensor 202A to generate the laser beam 205A or the ultrasonic pulses 206A as the chuck 108 moves along the Y axis. In some embodiments, the controller 118 can cause the axial sensor 202A to generate the laser beam 205A or the ultrasonic pulses 206A as the chuck 108 moves along the Z axis. In some embodiments, the axial sensor 202A can be moved in the Y or Z directions relative the front face 106 and can generate laser beam 205A or the ultrasonic pulses 206A at different positions.

In some embodiments, the axial sensor 202A can be positioned in front of the front face 106. The axial sensor 202A can be configured to measure a plurality of distances (for example, d₁, d₂, d₃) between the axial sensor 202A and various points on the front face 106 (for example, points along the Y or Z axis). The controller 118 can then compare the distances to identify the face plane 107 for comparison to the blade plane 112 to identify the orientation of the front face 106 relative to the blade surface 111. For example, if the face plane 107 is parallel to the blade plane 112, then d₁, d₂, d₃ would be expected to be equal. On the other hand, if one or more of d₁, d₂, d₃ are not the same, the face plane 107 is not parallel to the blade plane 112, and thus the sample block 105 may be moved by the chuck 108, re-aligned, or removed. In some embodiments, the controller 118 can use the distances to detect whether there are any protrusions on the front face 106 to identify whether the topography on the front face 106 is smooth or bumpy. For example, if the front face is smooth, then d₁, d₂, d₃ would be expected to be equal. In another example, if one or more of d₁, d₂, d₃ are not the same, then the front face 106 includes protrusions, and thus the sample block 105 can be moved by the chuck 108, shaved, or removed.

In some embodiments, the controller 118 can identify or maintain the blade plane 112. In some embodiments, the axial sensor 202A is configured to generate distance measurements transverse to the blade plane 112. In some embodiments, the axial sensor 202A is configured to generate distance measurements in the direction of the X axis at different points along the Y or Z axis. In some embodiments, the axial sensor 202A is configured to generate distance measurements perpendicular to the blade plane 112. In some embodiments, the axial sensor 202A is configured to generate distance measurements along or parallel to the X axis.

The controller 118 can use the axial sensor 202A to identify a distance to a point on the front face 106. In some embodiments, the controller 118 can cause the axial sensor 202A to identify the length of the laser beam 205A between the axial sensor 202A and the front face 106. In some embodiments, the controller 118 can cause the axial sensor 202A to identify the distance of the ultrasonic pulse 206A between the axial sensor 202A and the front face 106. For example, the controller 118 can cause the axial sensor 202A to identify the distance d₁ between the axial sensor 202A and the front face 106.

In some embodiments, the axial sensor 202A can identify a plurality of distances as the chuck 108 moves the sample block 105 along the Z axis (e.g., up and down) or Y axis (e.g., side to side) relative to the axial sensor 202A. The controller 118 can be configured to receive the plurality of distances from the axial sensor 202A. In some embodiments, the controller 118 can be configured to receive or identify the positions (e.g., Z and Y coordinates) of the chuck 108 as it moves. For example, the controller 118 can identify the positions from a motor moving the chuck 108. The controller 118 can associate the positions with each distance identified by the axial sensor 202A. For example, the controller 118 can identify a first distance between the axial sensor 202A and the front face 106 when the sample block 105 is at a first position along the Y and Z axes, a second distance between the axial sensor 202A and the front face 106 when the sample block 105 is at a second position along the Y and Z axes, and a third distance between the axial sensor 202A and the front face 106 when the sample block 105 is at a third position along the Y and Z axes.

In some embodiments, the axial sensor 202A can identify the plurality of distances by moving relative to a stationary sample block 105 along the Z axis (e.g., up and down) or Y axis (e.g., side to side). The controller 118 can be configured to receive or identify the positions (e.g., Z and Y coordinates) of the axial sensor 202A as it moves. For example, the controller 118 can identify the positions from a motor moving the axial sensor 202A. The controller 118 can associate the positions with each distance identified by the axial sensor 202A.

The controller 118 can be configured to use the plurality of distances between the axial sensor 202A and the sample block 105 to identify the face plane 107. In some embodiments, the controller 118 can identify the face plane 107 based on the Y and Z coordinates of each of the plurality of distances between the axial sensor 202A and the front face 106.

In some embodiments, the controller 118 can detect the face plane 107 of the front face 106 to identify that the front face 106 is parallel with the blade surface 111 if the differences among the plurality of distances are less than a threshold. For example, if each distance between the axial sensor 202A and the front face 106 is the same or within the threshold, then the laser beam 205A or the ultrasonic pulses 206A is perpendicular to the face plane 107 along the Y and Z axes. If the blade plane 112 is also perpendicular to the laser beam 205A along the Y and Z axes, then the blade plane 112 is parallel to the face plane 107. In some embodiments, the controller 118 can detect the topography of the front face 106 to identify the front face 106 is smooth if the differences among the plurality of distances are less than a threshold. In some embodiments, if each distance between the axial sensor 202A and the front face 106 is the same or within the threshold, then the front face 106 is smooth.

In some embodiments, the controller 118 can detect that the front face 106 is not parallel with the blade surface 111 if the differences among the distances exceed the threshold. For example, if one or more distances between the axial sensor 202A and the front face 106 exceed the threshold, then the laser beam 205A or the ultrasonic pulses 206A is not perpendicular to the face plane 107 along at least the Y or Z axis at one or more of the measured points. If the blade plane 112 is perpendicular to the laser beam 205A along the Y and Z axes, then the blade plane 112 is not parallel to the face plane 107. In some embodiments, the controller 118 can detect that the front face 106 is not smooth (e.g., bumpy) if the differences among the distances exceed the threshold. For example, if one or more distances between the axial sensor 202A and the front face 106 exceed the threshold, then the front face 106 is not smooth.

In some embodiments, as shown in FIG. 2C, the system 100 can include axial sensor 202A, axial sensor 202B, and axial sensor 202C configured to measure the distance to the front face 106 by generating laser beam 205A, laser beam 205B, and laser beam 205C directed at the front face 106. In some embodiments, as shown in FIG. 2D, the axial sensors 202A-202C can be configured to measure the distance to the front face 106 by generating ultrasonic pulses 206A, ultrasonic pulses 206B, and ultrasonic pulses 206C directed at the front face 106.

Now referring generally to FIGS. 2C and 2D, in some embodiments, the axial sensors 202A-202C can be positioned in front of the front face 106. The axial sensors 202A-202C can be configured to measure distances (for example, d₁, d₂, d₃) between each of the axial sensors 202A-202C and various points on the front face 106 (for example, points along the Y or Z axis). The controller 118 can then compare the distances to identify the face plane 107 for comparison to the blade plane 112 and to identify the orientation of the face plane 107 relative to the blade plane 112. For example, if the face plane 107 is parallel to the blade plane 112, then d₁, d₂, d₃ would be expected to be equal. On the other hand, if the distance d₃ is longer than distance d₁, and the distance d₁ is longer than d₂, the face plane 107 is not parallel to the blade plane 112, and thus the sample block 105 can be moved by the chuck 108, realigned, or removed. In some embodiments, the controller 118 can use the distances to detect the topography, for example, the presence of protrusions on the front face 106 to identify whether the topography of the front face 106 is smooth or bumpy. For example, if the front face 106 is smooth, then d₁, d₂, d₃ would be expected to be equal. In another example, if the distance d₃ is longer than distance d₁, and the distance d₁ is longer than d₂, then the front face 106 includes protrusions, and thus the sample block 105 can be moved by the chuck 108, shaved, or removed.

In some embodiments, the axial sensors 202A-202C are axially positioned on an identical point on the X axis but along a diagonal or pattern spanning the Z and Y axis. In some embodiments, the controller 118 can identify or maintain a position (e.g., x, y, z coordinates) of each of the axial sensors 202A-202C relative to each other. In some embodiments, the system 100 can include a different quantity (e.g., 5, 7, etc.) of axial sensors that together generate a respective number of measurements.

The controller 118 can cause the axial sensors 202A-202C to each measure the distance to the front face 106 by generating laser beams 205A-205C or the ultrasonic pulses 206A-206C. In some embodiments, the controller 118 can cause the axial sensors 202A-202C to generate the laser beams 205A-205C or the ultrasonic pulses 206A-206C at the sample block 105 in front of the axial sensors 202A-202C. In some embodiments, the controller 118 can cause the axial sensors 202A-202C to generate the laser beams 205A-205C or the ultrasonic pulses 206A-206C when the chuck 108 holding the sample block 105 is stationary. In some embodiments, the controller 118 can cause the axial sensors 202A-202C to generate the laser beams 205A-205C or the ultrasonic pulses 206A-206C as the chuck 108 moves the sample block 105.

In some embodiments, the controller 118 can store, maintain, or identify the blade plane 112. In some embodiments, the axial sensors 202A-202C are configured to generate distance measurements transverse to the blade plane 112. In some embodiments, the axial sensors 202A-202C are configured to generate distance measurements in the direction of the X axis at different points along the Y or Z axis. In some embodiments, the axial sensors 202A-202C are configured to measure the distances perpendicularly to the blade plane 112. In some embodiments, the axial sensors 202A-202C are configured to measure the distances along or parallel to the X axis.

The controller 118 can cause the axial sensors 202A-202C to identify the distance between each of the respective axial sensors 202A-202C and a respective point on the front face 106. In some embodiments, the controller 118 can cause each of the axial sensors 202A-202C to identify the distances at the same time while the sample block 105 is stationary. For example, the controller 118 can cause the axial sensor 202A to identify the distance d₁ between the axial sensor 202A and a first point on the front face 106, the axial sensor 202B to identify the distance d₂ between the axial sensor 202B and a second point on the front face 106, and the axial sensor 202C to identify the distance d₃ between the axial sensor 202C and a third point on the front face 106. The controller 118 can be configured to receive the distances from the axial sensors 202A-202C.

The controller 118 can be configured to use the position (e.g., x, y, z coordinates) of the axial sensors 202A-202C relative to each other and the plurality of distances between each of the respective axial sensors 202A-202C and the front face 106 to identify the face plane 107. The controller 118 can identify the face plane 107 based on the plurality of distances to the front face 106 along the Y and Z axes. In some embodiments, the controller 118 can identify the face plane 107 by identifying three angles formed between the blade plane 112 and a point on the front face 106. In some embodiments, the controller 118 can identify the face plane 107 by identifying three points on the front face 106. In some embodiments, the controller 118 can identify the face plane 107 by identifying a point on the front face 106 and a normal vector of the front face 106.

In some embodiments, the controller 118 can be configured to use the face plane 107 to identify an orientation of the front face 106 relative to the blade surface 111. For example, if the controller 118 identifies that the distance d₃ is longer than distance d₁, and that distance d₁ is longer than d₂, then the controller 118 can identify that the face plane 107 is not parallel with the blade plane 112. In some embodiments, the controller 118 can identify the topography of the front face 106 to identify whether the front face 106 is smooth or bumpy. In another example, if the controller 118 identifies that the distance d₃ is longer than distance d₁, and that distance d₁ is longer than d₂, then the controller 118 can identify that the front face 106 is not smooth.

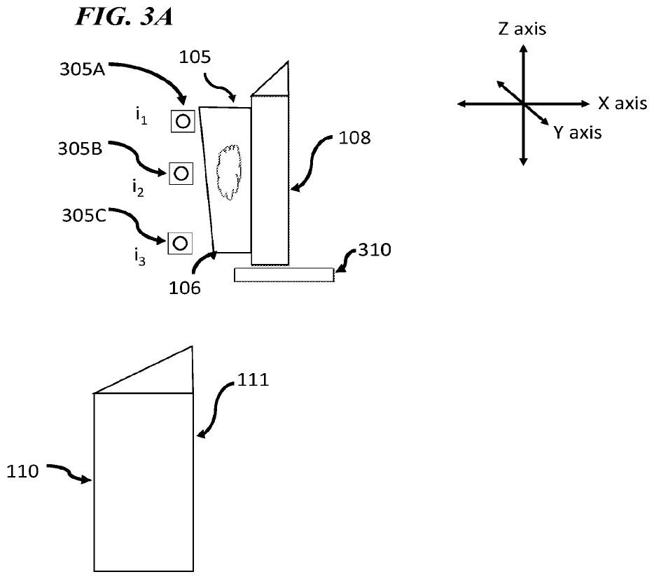

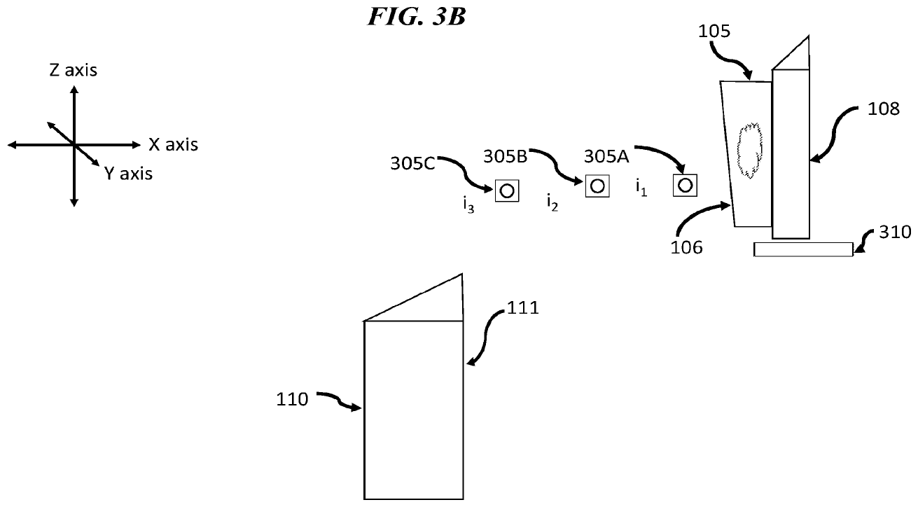

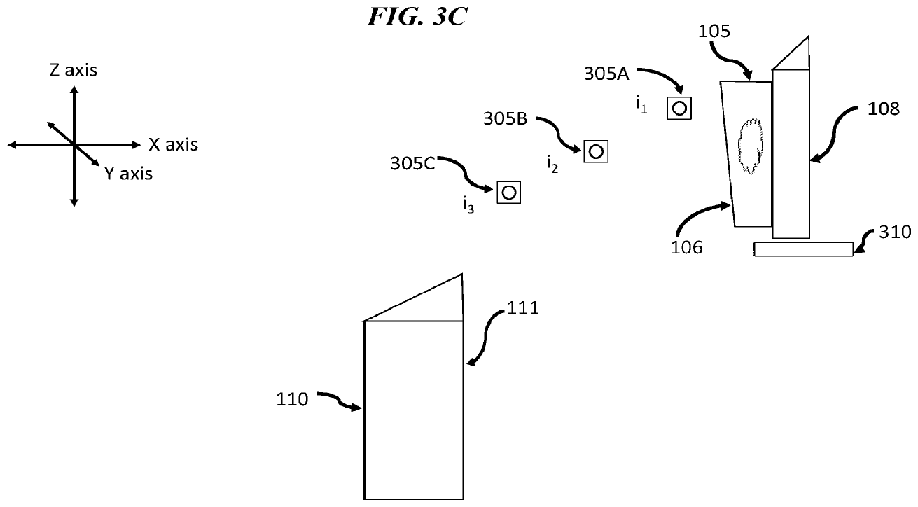

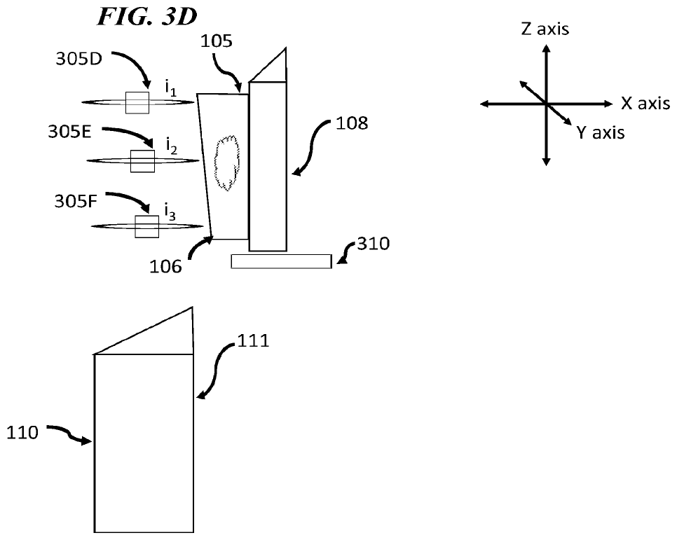

Now referring generally to FIGS. 3A-3D, in some embodiments, the surface sensor 116 can include one or more lateral sensors 305A-305F positioned along the side of the sample block 105 and configured to measure intersection points between signals of the lateral sensors 305A-305F and the front face 106 along the Y axis. In some embodiments, the intersection point is a data structure that includes x, y, z, coordinates indicative of the position of the intersection point relative to a known reference location. The controller 118 can then compare the intersection points to identify the face plane 107 for comparison to the blade plane 112 and to identify the orientation of the face plane 107 relative to the blade plane 112. In some embodiments, the controller 118 can use the intersection points to detect whether there are protrusions on the front face 106 to identify whether the topography of the front face 106 is smooth or bumpy.

In some embodiments, the lateral sensors 305A-305F can identify the distance along the Y axis between the lateral sensors 305A-305F and the front face 106 to identify the face plane 107. The controller 118 can then compare the distances to identify the face plane 107 for comparison to the blade plane 112 and to identify the orientation of the face plane 107 relative to the blade plane 112. For example, if the distances are the same or within a threshold, then the face plane 107 is parallel to the blade plane 112. Conversely, if one or more of the distances are not the same or the differences exceed the threshold, the face plane 107 is not parallel to the blade plane 112. In some embodiments, the controller 118 can use the distances to detect whether there are protrusions of the front face 106 to identify whether the topography of the front face 106 is smooth or bumpy. For example, if the distances are the same or within a threshold, then the front face 106 is smooth. In another example, if one or more of the distances are not the same or the differences exceed the threshold, then the front face 106 is not smooth.

In some embodiments, as shown in FIG. 3A-3C, the lateral sensors 305A-305C can be positioned along the side of the front face 106. The lateral sensors 305A-305C can be configured to identify intersections (for example, i₁, i₂, i₃) between their signals and various points on the front face 106 (for example, points along the Z axis or X axis) at various positions of the chuck 108. The controller 118 can then compare the intersections and positions to identify the face plane 107 for comparison to the blade plane 112 and to identify the orientation of the face plane 107 relative to the blade plane 112. For example, as shown in FIG. 3A, if i₁, i₂, i₃ are the same along the X axis (that is, the signals of the sensors 305A-305C all intersect with the front face 106 at the same time as the chuck 108 moves the sample block 105 in the X direction), then the face plane 107 is parallel to the blade plane 112. Conversely, if one or more of i₁, i₂, i₃ are not the same, the face plane 107 is not parallel to the blade plane 112. In another example, as shown in FIG. 3B, i₁, i₂, i₃ can be the same along the Z axis. The chuck 108 can move the sample block 105 to various points along the Z axis and then into the paths of the sensors 305A-305C. In doing so, and based on the intersections i₁, i₂, i₃, the thickness of the sample block 105 at different positions along the height of the sample block 105 (e.g. along the Z axis). Variations in the thickness can be indicative of the orientation of the front face 106. For instance, if i₁, i₂, i₃ are the same along the Z axis (e.g. occur at the same time when the chuck 108 is positioned at different points along the Z axis and advanced toward the sensors 305A-305C), then then the face plane 107 can be parallel to the blade plane 112. In contrast, if i₁, i₂, i₃ are different (e.g. occur at different times when the chuck 108 is positioned at different points along the Z axis and advanced toward the sensors 305A-305C), the face plane 107 is not parallel to the blade plane 112. In another example, as shown in FIG. 3C, if i₁, i₂, i₃ are the same after compensating for the distance between the lateral sensors 305A-305C and the positions of the chuck 108 at each intersection, then the face plane 107 is parallel to the blade plane 112 along the Y and Z axis. Conversely, if one or more of i₁, i₂, i₃ are not the same, the face plane 107 is not parallel to the blade plane 112.

In some embodiments, the controller 118 can use the intersections to detect whether there are protrusions on the front face 106 to identify whether the topography of the front face 106 is smooth or bumpy. For example, as shown in FIG. 3A, if i₁, i₂, i₃ are the same along the X axis (e.g. occur at the same time as the chuck 108 moves along the X axis as described above), then the front face 106 is smooth. Conversely, if one or more of i₁, i₂, i₃ are not the same, the front face 106 is not smooth. In another example, as shown in FIG. 3B, if i₁, i₂, is are the same along the Z axis (e.g. occur at the same time when the chuck 108 is positioned at different points along the Z axis and advanced toward the sensors 305A-305C), then the front face 106 is smooth. Conversely, if one or more of i₁, i₂, i₃ are not the same, the front face 106 is not smooth. In another example, as shown in FIG. 3C, if i₁, i₂, i₃ are the same after compensating for the distance between the lateral sensors 305A-305C and the positions of the chuck 108 at each intersection, then the front face 106 is smooth. Conversely, if one or more of i₁, i₂, i₃ are not the same, the front face 106 is not smooth.

In some embodiments, the surface sensor 116 can include the one or more lateral sensors 305A-305C (e.g., non-contact reflective laser sensors or ultrasonic sensors) generating measurements of the front face 106 along the Y axis. As shown in FIG. 3A, the lateral sensors 305A-305C have the same position on the X and Y axes but different positions along the Z axis. In some embodiments, the surface sensor 116 includes the axial sensors 202A-202C and the lateral sensors 305A-305C configured to generate a laser grid for identifying the face plane 107. As shown in FIG. 3B, the lateral sensors 305A-305C have the same position on the Y and Z axes but different positions along the X axis. As shown in FIG. 3C, the lateral sensors 305A-305C have the same position on the Y axis but different positions along the X and Z axes. In some embodiments, the lateral sensors 305A-305C can be laterally positioned and configured to generate laser beams or ultrasonic pulses that are parallel to the blade plane 112 along the Y axis. In some embodiments, the system 100 can include a different quantity (e.g., 5, 7, etc.) of lateral sensors that generate a respective number of measurements.

As shown in FIG. 3D, in some embodiments, the lateral sensors 305D-305F can be positioned in front of the front face 106. The lateral sensors 305D-305F can be configured to identify intersections (for example, i₁, i₂, i₃) between each of the lateral sensors 305D-305F and various points on the front face 106 (for example, points along the X or Z axis).

The controller 118 can compare the intersections to identify the face plane 107 for comparison to the blade plane 112 and to identify whether the front face 106 is parallel relative to the blade surface 111. For example, as shown in FIG. 3D, if i₁, i₂, i₃ occur at same time, then the face plane 107 is parallel to the blade plane 112 along the Y and Z axis. Conversely, if one or more of i₁, i₂, i₃ are not the same, the face plane 107 is not parallel to the blade plane 112.

In some embodiments, the controller 118 can use the intersections to detect whether there are protrusions on the front face 106 to identify whether the topography of the front face 106 is smooth. For example, as shown in FIG. 3D, if i₁, i₂, i₃ occur at same time, then the front face 106 is smooth. In another example, if one or more of i₁, i₂, i₃ are not the same, then the front face 106 is not smooth.

In some embodiments, the lateral sensor 305D, lateral sensor 305E, and lateral sensor 305F can generate a lateral laser sheet (also known as a fan) in which to immerse the sample block 105. In some embodiments, the system 100 can include a different quantity (e.g., 5, 7, etc.) of lateral sensors that generate a respective number of lateral laser sheets. In some embodiments, the laser sheet can be directed parallel to the Y axis and spread out across the X axis. In some embodiments, the lateral sensors 305D-305F have the same position on the X and Y axes but different positions along the Z axis, but the laser sheet enables the identification of intersection points along the X axis and the variation in position of the lateral sensors 305D-305F along the Z axis enables identifying the face plane 107. In some embodiments, the lateral sensors 305D-305F have the same position on the Y and Z axes but different positions along the X axis. In some embodiments, the lateral sensors 305D-305F have the same position on the Y axis but different positions along the X and Z axes.

Now referring to FIGS. 3A-3D, in some embodiments, the controller 118 can identify or maintain the position (e.g., x, y, z coordinates) of each of the lateral sensors 305A-305F relative to each other. In some embodiments, the controller 118 can identify or maintain a position (e.g., x, y, z coordinates) of each of the lateral sensors 305A-305F relative to the chuck 108 or the blade 110. In some embodiments, the controller 118 can use the position of the lateral sensors 305A-305C to identify the position of their respective intersection points. For example, if the lateral sensor 305A is 1 cm away from the lateral sensor 305B along the Z axis, then the position of the intersection points i₁ and i₂ will be separated by 1 cm on the Z axis.

The system 100 can include a position sensor 310, which can identify a position of the chuck 108 holding the sample block 105. The controller 118 can associate the position of the chuck 108 with the intersection points. For example, the controller 118 can identify where the chuck 108 is located when the sample block 105 intersects the laser beam or ultrasonic pulse of the lateral sensor 305A. In some embodiments, the controller 118 can receive, from the position sensor 310, the position (e.g., x, y, z coordinates) of the chuck 108. In some embodiments, the position sensor 310 can sense the motion the chuck 108 without contacting the chuck itself. For example, the resolution of the position sensor 310 can be in the range of 50 nm to 100 nm. A benefit of the position sensor 310 can be that there is an insignificant added mass to the system 100 or chuck 108.

Now referring to FIGS. 3A-3C, the controller 118 can cause the lateral sensors 305A-305C to each identify the intersection point with the front face 106 by generating laser beams or ultrasonic pulses to sense or identify the front face 106. The controller 118 can cause the chuck 108 holding the sample block 105 to move towards the blade 110 until the sample block 105 crosses a laser beam or ultrasonic pulse of the lateral sensors 305A-305C. In some embodiments, the controller 118 can cause the lateral sensors 305A-305C to generate the laser beams or ultrasonic pulses as the chuck 108 moves the sample block 105 in front of (e.g., perpendicular to) the lateral sensors 305A-305C. In some embodiments, the controller 118 can cause the lateral sensors 305A-305C to generate the laser beams or ultrasonic pulses as the chuck 108 moves towards the sample block 105.

In some embodiments, the controller 118 can cause the chuck 108 to move the sample block 105 to a plurality of positions to identify a plurality of intersections points. The controller 118 can identify intersection points (e.g., i₁-i₃) corresponding to where laser beams or ultrasonic pulses of the lateral sensors 305A-305C intersected with the front face 106. For example, the controller 118 can cause the lateral sensors 305A-305C to identify a first set of intersection points between the laser beam or ultrasonic pulses and the front face 106 when the chuck 108 is at a first position, and then identify a second set and third set of intersection points when the chuck 108 is at a second and third position, respectively. In some embodiments, the controller 118 can cause the chuck 108 to move to a different position along the X and Z axes and identify another position of the chuck 108 when the front face 106 crosses the laser beam or ultrasonic pulse. For example, the controller 118 can identify or measure at least 3 intersection points where the front face 106 crosses the laser beam or ultrasonic pulse.

Now referring to FIG. 3D, the controller 118 can cause the chuck 108 to move the sample block 105 to be immersed by the laser sheet. For example, the controller 118 can cause the chuck 108 to move the sample block 105 until the sample block 105 crosses the laser sheet generated by all three lateral laser sheet sensors 305D-305F. In some embodiments, the controller 118 can cause the lateral laser sheet sensors 305D-305F to generate the laser sheet when the sample block 105 is stationary in front of the lateral laser sheet sensors 305D-305F. This embodiment can be time efficient since a plurality of intersection points can be identified at one position of the sample block 105. In some embodiments, the controller 118 can cause the chuck 108 to move the sample block 105 to a plurality of positions to identify additional intersections points.

In some embodiments, one lateral sensor can identify a plurality of intersections by moving along the X axis (e.g., side to side) or the Z axis (e.g., up and down) relative to the front face 106. The controller 118 can be configured to receive the plurality of intersections from the lateral sensor. The controller 118 can be configured to receive or identify the positions (e.g., x, y, z coordinates) of the lateral sensor as it moves. For example, the controller 118 can identify the positions from a motor moving the lateral sensor. The controller 118 can associate the positions with each intersection identified by the lateral sensor. For example, the controller 118 can identify a first intersection between the beams of the lateral sensor and the front face 106 when the lateral sensor is at a first position along the X and Z axes, a second intersection between the beams of the lateral sensor and the front face 106 when the lateral sensor is at a second position along the X and Z axes, and a third intersection between the beams of the lateral sensor and the front face 106 when the lateral sensor is at a third position along the X and Z axes.

In some embodiments, one lateral sensor can identify a plurality of intersections by moving the chuck 108 holding the sample block 105 along the X axis (e.g., side to side) or the Z axis (e.g., up and down) relative to the lateral sensor. The controller 118 can be configured to receive the plurality of intersections from the lateral sensor. The controller 118 can be configured to receive or identify, from the position sensor 310, the positions (e.g., x, y, z coordinates) of the chuck 108 as it moves. The controller 118 can associate the positions with each intersection identified by the lateral sensor. For example, the controller 118 can identify a first intersection between the beams of the lateral sensor and the front face 106 when the chuck 108 is at a first position along the X and Z axes, a second intersection between the beams of the lateral sensor and the front face 106 when the chuck 108 is at a second position along the X and Z axes, and a third intersection between the beams of the lateral sensor and the front face 106 when the chuck 108 is at a third position along the X and Z axes.

Now referring to FIGS. 3A-3D, the controller 118 can be configured to use the plurality of intersections to identify the face plane 107. In some embodiments, the controller 118 can identify the face plane 107 based on the position of the plurality of intersections with the front face 106 along the Y and Z axes. In some embodiments, the controller 118 can be configured to identify the orientation of the face plane 107 with respect to the blade plane 112 by comparing the face plane 107 to the blade plane 112. In some embodiments, the controller 118 can use the intersections to detect whether there are protrusions on the front face 106 to identify whether the topography of the front face 106 is smooth.

For example, the chuck 108 can move the sample block 105 and the lateral sensor 305A would identify an intersection at i₁ with the front face 106. The controller 118 would receive and store the intersection i₁. The controller 118 would receive and store a position, P₁, of the chuck 108 from the position sensor 310 when the intersection i₁ occurs. As the sample block 105 continues moving towards the blade 110, the lateral sensor 305B would identify an intersection at i₂ with the front face 106. The controller 118 would receive and store the intersection i₂. The controller 118 would receive and store a position, P₂, of the chuck 108 from the position sensor 310 when the intersection i₂ occurs.

In some embodiments, the controller 118 can identify the face plane 107 based on two intersection points. For example, the controller 118 can identify the plane based on the angles formed between the points i₁ and i₂ with P₂. The controller 118 can use the angles among the points and P₂ to identify the face plane 107.

In some embodiments, the controller 118 can identify the face plane 107 based on three intersection points. For example, as the sample block 105 continues moving towards the blade 110, the lateral sensor 305C would identify an intersection at i₃ with the front face 106. The controller 118 would receive and store the intersection is. The controller 118 would receive and store a position, P₃, of the chuck 108 from the position sensor 310 when the intersection i₃ occurs. In some embodiments, the controller 118 can identify the angles formed between the points i₁, P₁ and i₂, P₂ and i₃, P₃. The controller 118 can use three angles among the points to confirm the identified plane or improve the accuracy of the calculations.

The controller 118 can identify whether the face plane 107 is parallel with respect to the blade plane 112. For example, as shown in FIG. 3A, if i₁, i₂, i₃ occur at the same time, then the face plane 107 is parallel to the blade plane 112. Conversely, if one or more of i₁, i₂, i₃ do not occur at the same time, then the face plane 107 is not parallel to the blade plane 112.

The controller 118 can identify whether there are protrusions on the front face 106 to determine whether the topography of the front face 106 is smooth. For example, as shown in FIG. 3A, if i₁, i₂, i₃ occur at the same time, then the front face 106 is smooth. Conversely, if one or more of i₁, i₂, i₃ do not occur at the same time, then the front face 106 is not smooth

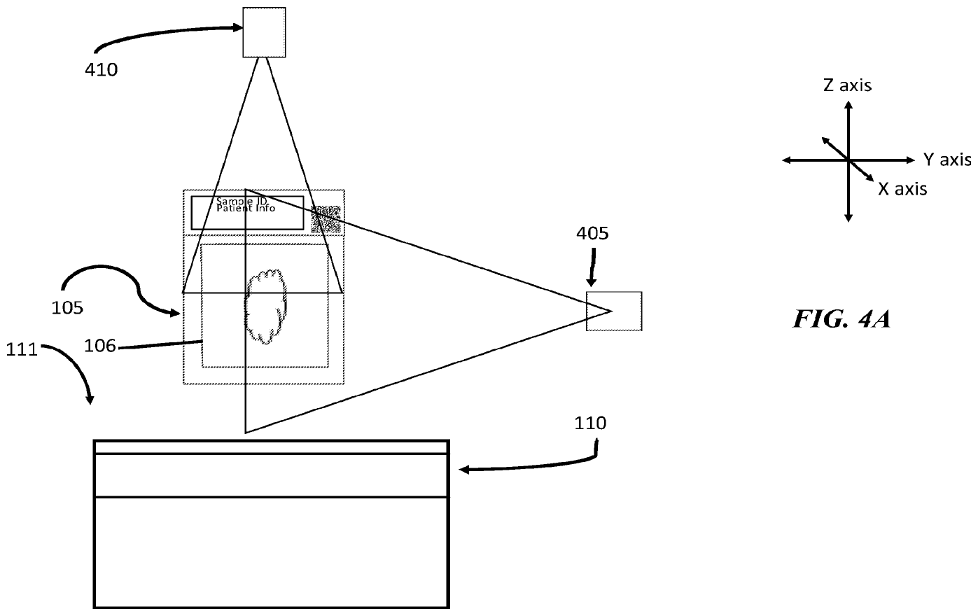

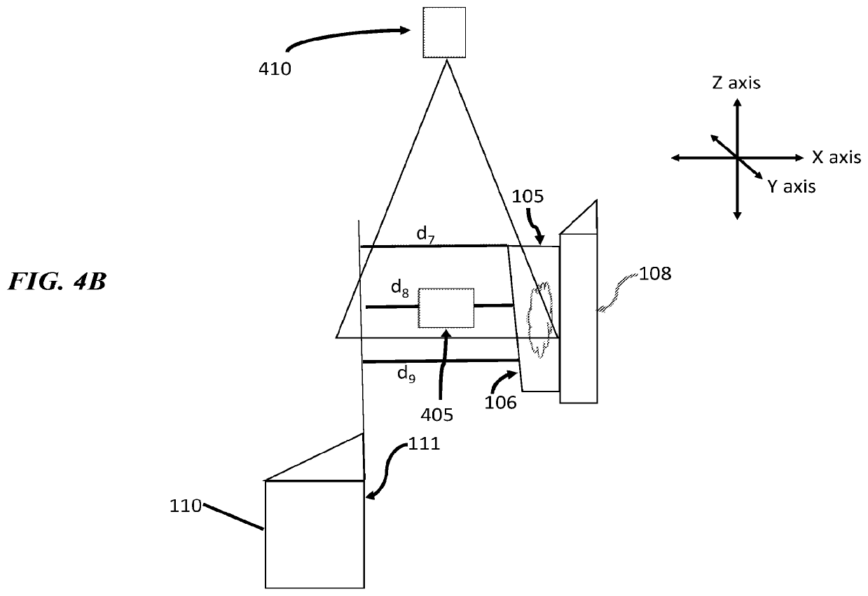

In some embodiments, as shown in the front view in FIG. 4A and the side view in FIG. 4B, the surface sensor 116 can include a longitudinal camera 410 (e.g., top or bottom camera) capturing images along the Z axis and the lateral camera 405 (e.g., side camera) capturing images along the Y axis. The controller 118 can cause the lateral camera 405 and longitudinal camera 410 to each capture images of the sample block 105 to identify or sense the geometry of the front face 106. In some embodiments, the controller 118 can use the images to detect the orientation of the front face 106 relative to the blade surface 111 by comparing the face plane 107 to the blade plane 112. In some embodiments, the controller 118 can use the images to detect whether there are protrusions on the front face 106 to identify whether the topography on the front face 106 is smooth.

In some embodiments, the controller 118 can cause the lateral camera 405 and longitudinal camera 410 to capture images as the chuck 108 moves the sample block 105 in front of the lateral camera 405 and longitudinal camera 410 to be cut by the blade surface 111. In some embodiments, the controller 118 can cause the lateral camera 405 and longitudinal camera 410 to capture images as the chuck 108 moves the sample block 105. In some embodiments, the controller 118 can cause the chuck 108 holding the sample block 105 to move until the sample block 105 is in the view of the lateral camera 405 and longitudinal camera 410.

In some embodiments, the lateral camera 405 and the longitudinal camera 410 are high-speed cameras used to trace marker pixels throughout the motion of the sample block 105 and blade 110 during a sectioning process. In some embodiments, the cameras are high-speed cameras that can determine changes in the speed of the microtome as well as displacement changes of the sample block 105 by the blade at various speeds, such as, for example between at 540 and 580 fps or 560 fps. In some embodiments, the lateral camera 405 and longitudinal camera 410 can be one of a high speed, a still image, or a video camera or a similar imaging sensor. In some embodiments, the controller 118 can associate the position of the chuck 108 with the images. In some embodiments, the controller 118 can identify where the chuck 108 is located in particular images captured by the lateral camera 405 and longitudinal camera 410. In some embodiments, the controller 118 receives the position of the chuck 108 from the position sensor 310 and associates the position with the images.

In some embodiments, the controller 118 can use the images collected by the lateral camera 405 and longitudinal camera 410 to identify the geometry of the front face 106. In some embodiments, the controller 118 can use the images to detect the orientation of the front face 106 relative to the blade surface 111 by comparing the face plane 107 to the blade plane 112. In some embodiments, the controller 118 can be configured to identify the orientation of the face plane 107 and compare the face plane 107 to that of the blade plane 112 to identify whether the front face 106 is parallel with the blade surface 111. In some embodiments, the controller 118 can use the images to detect whether there are protrusions on the front face 106 to identify whether the topography the front face 106 is smooth. In some embodiments, the controller 118 can identify pixels in the images to identify the face plane 107. In some embodiments, the controller 118 can identify pixels in the images to identify the blade plane 112. In some embodiments, the controller 118 can use the position of the chuck 108 received from the position sensor 310 to assist in identifying pixels in the images that identify the face plane 107. In some embodiments, the controller 118 may have a pixel count variance and the pixel count variance in a given direction can be attributable to the dimensions or depth in the front face 106. In some embodiments, the controller 118 can employ optical measurements, using one or both of the lateral camera 405 and longitudinal camera 410 to obtain optical test data to confirm and compare the geometry of the front face 106.

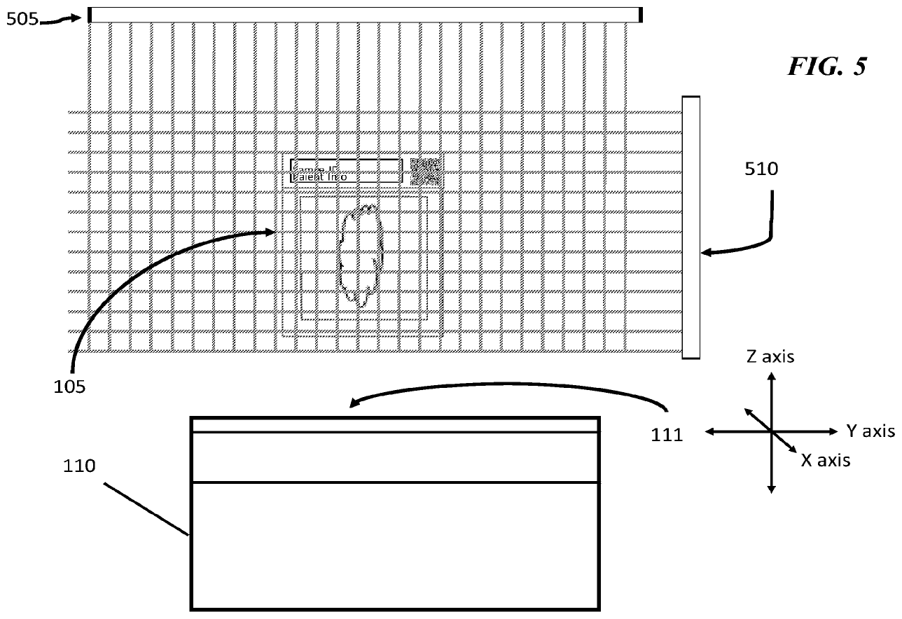

In some embodiments, as shown in FIG. 5, the surface sensor 116 can include a longitudinal laser grid sensor 505 (e.g., top laser) generating a plurality of laser beams along the Z axis and a lateral laser grid sensor 510 (e.g., side laser) generating a plurality of laser beams along the Y axis. The longitudinal laser grid sensor 505 and the lateral laser grid sensor 510 can be configured to measure intersection points between the lasers and the front face 106 along the Y and Z axes. The controller 118 can then compare the intersection points to identify the face plane 107 for comparison to the blade plane 112 and to identify the orientation of the front face 106 relative to the blade surface 111. For example, if the face plane 107 is parallel to the blade plane 112, the intersection points would be expected to occur at the same time along the Z and Y axes. On the other hand, if one or more of the intersection points do not occur at the same time, the face plane 107 is not parallel to the blade plane 112.

In some embodiments, the controller 118 can use the intersections to detect whether there are protrusions on the front face 106 to identify whether the topography of the front face 106 is smooth. For example, if the front face 106 is smooth, the intersection points would be expected to occur at the same time along the Z and Y axes. On the other hand, if one or more of the intersection points do not occur at the same time, the front face 106 is not smooth.

The longitudinal laser grid sensor 505 and the lateral laser grid sensor 510 can generate the laser beams to generate a laser grid to divide the sample block 105 into volumes marked by the laser grid to identify or sense the front face 106. In some embodiments, the longitudinal laser grid sensor 505 comprises a plurality of discrete laser sensors that can be similar to the axial sensors 202A-202C or the lateral sensors 305A-305C. In some embodiments, the lateral laser grid sensor 510 comprises a plurality of discrete laser sensors that can be similar to the axial sensors 202A-202C or the lateral sensors 305A-305C. In some embodiments, the controller 118 can cause the longitudinal laser grid sensor 505 and the lateral laser grid sensor 510 to generate the laser grid when the sample block 105 is stationary in front of the longitudinal laser grid sensor 505 and the lateral laser grid sensor 510. In some embodiments, the controller 118 can use the position sensor 310 to identify that the sample block 105 is stationary. In some embodiments, the controller 118 can cause the longitudinal laser grid sensor 505 and the lateral laser grid sensor 510 to generate the laser grid as the chuck 108 moves the sample block 105.

The controller 118 can use the longitudinal laser grid sensor 505 and the lateral laser grid sensor 510 to record or identify the intersection points on the laser grid with the sample block 105. In some embodiments, the controller 118 can cause the longitudinal laser grid sensor 505 and the lateral laser grid sensor 510 to generate the laser grid when the sample block 105 is stationary. This embodiment can be time efficient since a plurality of intersection points can be identified at one position of the sample block 105. In some embodiments, the controller 118 can identify a position (e.g., y, z coordinates) of the intersection points on the laser grid.

In some embodiments, the controller 118 can cause the chuck 108 to move the sample block 105 to a plurality of positions to identify additional intersections points. In some embodiments, the controller 118 can associate the position of the chuck 108 with the intersection points. For example, the controller 118 can identify the position of the chuck 108 each time the front face 106 intersects the laser grid. In some embodiments, the controller 118 receives the position of the chuck 108 from the position sensor 310 and associates the position with the intersection points.

In some embodiments, the controller 118 can identify the face plane 107 based on the intersection points. For example, if the face plane 107 is parallel to the blade plane 112, the intersection points would be expected to occur at the same time along the Z and Y axes. On the other hand, if one or more of the intersection points do not occur at the same time, the face plane 107 is not parallel to the blade plane 112. In some embodiments, the controller 118 can identify the face plane 107 based on the angles formed between the intersection points and the positions of the chuck 108. For example, if the controller 118 identifies that the intersection points are in the shape of a curve, then the controller 118 can identify that the front face 106 is tilted.

In some embodiments, the controller 118 can use the intersection points to detect whether there are protrusions on the front face 106 to identify whether the topography of the front face 106 is smooth. For example, if the front face 106 is smooth, the intersection points would be expected to occur at the same time along the Z and Y axes. On the other hand, if one or more of the intersection points do not occur at the same time, the front face 106 is not smooth. In some embodiments, the controller 118 can identify the protrusions based on the angles formed between the intersection points and the positions of the chuck 108. For example, if the controller 118 identifies that the intersection points are in the shape of a curve, then the controller 118 can identify that the front face 106 includes protrusions.

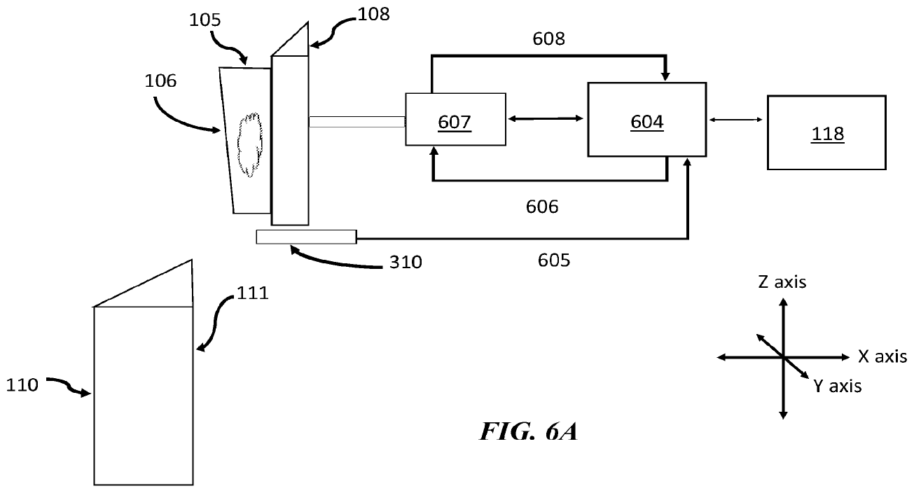

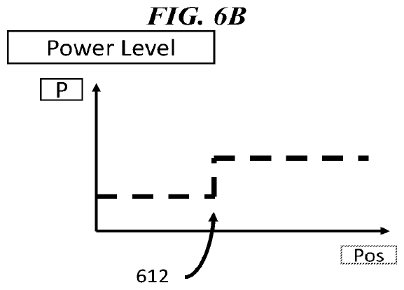

Now referring to FIGS. 6A and 6B, the surface sensor 116 can identify the geometry of the front face 106 based on power utilized to move the chuck 108. If the blade surface 111 touches the front face 106, the motor 607 would need to use more power to move the chuck 108. The position sensor 310 can record or identify the position of the chuck 108 when the motor 607 uses more power. The controller 118 can identify the point of contact in the position measurements 605 received by the motor controller 604 from the position sensor 310. The controller 118 can identify the power utilization in the power measurements 608 received by the motor controller 604 from the motor 607. This detection can be repeated at various positions along the Y and Z axes. For example, the chuck 108 can be moved to various positions in the Y-Z plane. At each position, the chuck 108 can be advanced in the X direction toward the blade surface 111. If the face plane 107 is parallel to the blade plane 112, the power required to move the chuck 108 in the X direction would be constant across all positions in the Y-Z plane (i.e. the front face 106 would contact the blade surface 111 at the same X coordinate for every chuck 108 position in the Y-Z plane). If the face plane 107 is not parallel to the blade plane 112, the power required to move the chuck 108 in the X direction would not be constant across all positions in the Y-Z plane (i.e. the front face 106 would contact the blade surface 111 at different X coordinates for at least some chuck 108 position in the Y-Z plane).

In some embodiments, the controller 118 can use the power utilization to detect whether there are protrusions on the front face 106 to identify whether the topography of the front face 106 is smooth or bumpy. For example, if the front face 106 includes bulges, more power would be used to push the chuck 108 when the bulge of the front face 106 touches the blade surface 111. On the other hand, if the power drawn to advance the chuck 108 stays constant while the chuck 108 is moved to different positions on the Y-Z, the front face 106 is smooth.

In some embodiments, as shown in FIG. 6A, the system 100 can include the sample block 105, the blade 110, the position sensor 310, a controller 118, and a motor controller 604 configured to receive position measurements 605 from the position sensor 310, transmit a drive signal 606 to the motor 607, and receive a power measurements 608 from the motor 607.

The controller 118 can be configured to manage the motor controller 604, which itself is configured to manage the motor 607. The controller 118 can be configured to identify the position measurements 605 received by the motor controller 604 from the position sensor 310. The controller 118 can identify, in the position measurements 605, positioning coordinates (e.g., x, y, z dimension) of the chuck 108 holding the sample block 105.

The controller 118 can cause the motor controller 604 to transmit a drive signal 606 to the motor 607 to cause the motor 607 to move the chuck 108 and the sample block 105 towards the blade 110. The controller 118 can cause the motor controller 604 to transmit the drive signal 606 to the motor 607. The controller 118 can select parameters for the drive signal 606 such as torque, speed, and direction. In some embodiments, the controller 118 can select the parameters based on the positioning coordinates in the position measurements 605. In some embodiments, the controller 118 can select the parameters from a lookup table corresponding to positions of the sample block 105. The controller 118 can cause the motor controller 604 to transmit the drive signal 606 to the motor 607.

The motor 607 can be configured to move the chuck 108 holding the sample block 105. In some embodiments, the motor 607 can move the chuck 108 holding the sample block 105 based on the drive signal 606. The motor 607 can be configured to use power to move the chuck 108 holding the sample block 105. In some embodiments, in response to receiving the drive signal 606, the motor 607 can be configured to use power to move the chuck 108 holding the sample block 105.

In some embodiments, as shown in FIG. 6A and FIG. 6B, the controller 118 can identify the power usage of the motor 607 (identified in the power measurements 608) at a plurality of positions of the chuck 108 holding the sample block 105 (identified in the position measurements 605). In some embodiments, the controller 118 communicates directly with the motor 607 to receive the power measurements 608. For example, the controller 118 can communicate with a sensor of the motor 607 to receive the power measurements 608. The controller 118 can identify the power usage parameters (e.g., voltage, current, resistance, rotations per minute, etc.) in the power measurements 608.

In some embodiments, the controller 118 can cause the motor controller 604 to cause the motor 607 to move the chuck 108 holding the sample block 105 to one or more (e.g., three) unique positions (e.g., along the Y and Z axes). The controller 118 can identify, in the power measurements 608 received by the motor controller 604 from the motor 607, the power usage of the motor 607 at each position of the chuck 108. For instance, the controller 118 can identify, in the power measurements 608 received by the motor controller 604 from the motor 607, the power usage of the motor 607 to advance the chuck 108 in the X direction at each position of the chuck 108.

In some embodiments, the controller 118 can cause the motor controller 604 to cause the motor 607 to move the chuck 108 around to detect and measure a baseline of expected power usage by the motor 607. In some embodiments, the controller 118 can detect and measure the magnitude and phase shifts of the power usage to determine a baseline or expected power usage to compare against during use to identify the increase in power usage. In some embodiments, the controller 118 can use an algorithm to compare deviation of peak frequencies to the baseline and decide based on those deviations whether an increase in power usage occurred.

As shown in FIG. 6B, the controller 118 can identify a power spike 612 indicating that the power usage (identified from the power measurements 608) exceeded a predetermined limit at a position of the chuck 108 (identified from the position measurements 605). For example, if the face plane 107 is tilted about the Y axis with respect to the Z axis, the motor would need to push harder and use more power to move the chuck 108 when the front face 106 touches the blade surface 111. For example, if the face plane 107 is tilted about the Y axis with respect to the Z axis, the motor would need to push harder and use more power to move the chuck 108 forward (in the X direction) at certain Y-Z positions than others based on when the front face 106 touches the blade surface 111. In another example, if the front face 106 includes a bulge, the motor 607 would need to push harder and use more power to move the chuck 108 when the bulge of the front face 106 touches the blade surface 111. For example, when there is a bulge in the front face 106, the motor would need to push harder and use more power to move the chuck 108 forward (in the X direction) at certain Y-Z positions than others based on when the front face 106 touches the blade surface 111. In some embodiments, the controller 118 can cause the motor controller 604 to stop the motor 607 and thus the sample block 105 responsive to identifying the power spike 612. Upon causing the motor 607 to stop, the controller 118 can record the position of the chuck 108 holding the sample block 105. In some embodiments, the controller 118 can identify a plurality of power spikes by moving the chuck 108 along the Y axis (e.g., side to side) or the Z axis (e.g., up and down) relative to the blade surface 111. The controller 118 can be configured to receive or identify, from the position sensor 310, the positions (e.g., x, y, z coordinates) of the chuck 108 at each of the power spikes.

The controller 118 can use the position measurements 605 and the power measurements 608 to identify or calculate the face plane 107 for comparison to the blade plane 112 to identify the orientation of the front face 106 with respect to the blade 110. Based on the position of the chuck 108 at each power spike, the controller 118 can calculate the face plane 107 for comparison to the blade plane 112 and to identify the orientation of the front face 106 with respect to the blade 110. In some embodiments, if the power drawn stays constant (e.g., no power spikes) while the chuck 108 is moved, the face plane 107 is parallel to the blade plane 112. In some embodiments, if the face plane 107 is not parallel to the blade plane 112, more power would be used to push the chuck 108 when the front face 106 touches the blade surface 111. In an example, if the face plane 107 is not parallel to the blade plane 112, the motor would need to push harder and use more power to move the chuck at certain positions than others based on when the front face 106 touches the blade surface 111. In an example, the controller 118 can identify the face plane 107 based on the position of the chuck 108 during three power spikes. If the three power spikes are associated with movements of the chuck 108 along the Z axis, then the face plane 107 might be tilted about the Y axis with respect to the blade plane 112.

The controller 118 can use the position measurements 605 and the power measurements 608 to identify whether there are protrusions on the front face 106 to identify whether the topography of the front face 106 is smooth. In some embodiments, the controller 118 can use the power spikes to detect whether there are protrusions on the front face 106 to identify whether the topography of the front face 106 is smooth. In some embodiments, if the power drawn stays constant (e.g., no power spikes) while the chuck 108 is moved, then the front face 106 is smooth. In some embodiments, if the front face 106 includes bulges, more power would be used to push the chuck 108 when the bulge of the front face 106 touches the blade surface 111. In an example, if the front face 106 includes one or more bulges, the motor would need to push harder and use more power to move the chuck 108 at certain positions than others based on when the front face 106 touches the blade surface 111. In an example, the controller 118 can identify whether there are protrusions on the front face 106 based on the position of the chuck 108 during three power spikes. If the three power spikes are associated with movements of the chuck 108 along the Z axis, then the front face 106 might include a protrusion.

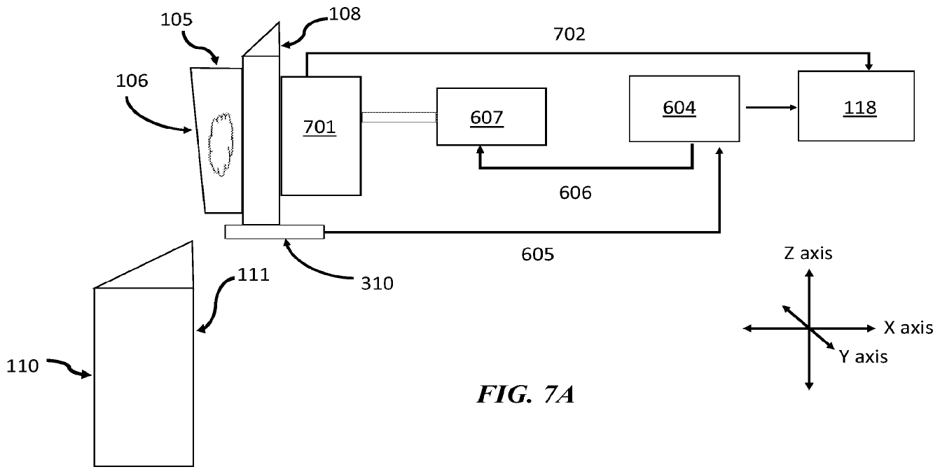

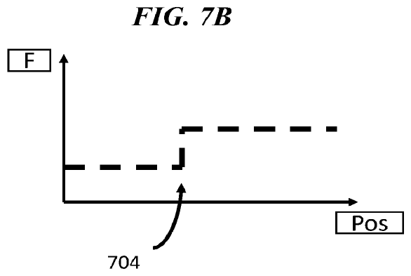

Now referring to FIGS. 7A and 7B, in some embodiments, the surface sensor 116 can identify the geometry of the front face 106 based on force applied by the blade surface 111 to the front face 106. For example, the front face 106 includes a paraffin layer protecting the tissue inside the sample block 105. When the blade surface 111 approaches and gently touches the paraffin layer such that the tissue is not affected, an increase in force measurements can indicate contact. The position sensor 310 can record or identify the position of the chuck 108 when the increase in force measurements occurs. The controller 118 can identify the point of contact in the position measurements 605 received by the motor controller 604 from the position sensor 310. This touch point displacement detection can be repeated at various positions along the Y and Z axes. For example, if the face plane 107 is titled about the Y axis with respect to the blade plane 112, the force measurements would increase as the chuck 108 moves the sample block 105 and thus the front face 106 against the blade surface 111. In some examples, if the face plane 107 is tilted with respect to the blade plane 112 and the chuck 108 is advanced toward the blade surface 111 at different positions in the Y-Z plane, the contact force measurements between the sample block 105 and blade 110 would be detected at different points of advancement of the chuck 108 along the X axis depending on the particular Y-Z positioning of the chuck 108. On the other hand, if the force measurements stay constant (e.g. across the different Y-Z positions of the chuck 108) while the chuck 108 moves toward the blade surface in the X direction, the face plane 107 is parallel to the blade plane 112.

In some embodiments, the controller 118 can use the force measurements to detect whether there are protrusions on the front face 106 to identify whether the topography of the front face 106 is smooth or bumpy. For example, if the front face 106 includes bulges, the force measurements would increase as the chuck 108 moves the sample block 105 and thus the bulge of the front face 106 against the blade surface 111. For instance, if the front face 106 includes a bulge and the chuck 108 is advanced toward the blade surface 111 at different positions in the Y-Z plane, the contact force measurements between the sample block 105 and the blade 110 would be detected at different points of advancement of the chuck 108 along the X axis depending on the particular Y-Z positioning of the chuck 108. On the other hand, if the force measurements stay constant while the chuck 108 moves, the front face 106 is smooth. For example, if the force measurements stay constant (e.g. across the different Y-Z positions of the chuck 108) while the chuck 108 moves toward the blade surface in the X direction, the front face 106 is smooth.

In some embodiments, as shown in FIG. 7A, the surface sensor 116 can be a force sensor or load cell 701 to identify the geometry of the front face 106. The system 100 can include the sample block 105, the blade 110, the position sensor 310, the controller 118, the motor controller 604, the motor 607, and the load cell 701 transmitting a force measurements 702 to the controller 118.

In some embodiments, the load cell 701 can be positioned on a surface of the chuck 108 configured to receive the sample block 105. In some embodiments, the load cell 701 is a force sensor configured to measure the forces acting on it. The load cell 701 can be placed on the force path between the sample block 105 and the blade 110. The load cell 701 can detect or measure forces applied to the chuck 108 by the sample block 105 to estimate the forces applied by the blade 110 to the sample block 105.

In some embodiments, as shown in FIG. 7B, the controller 118 can identify the force (identified in the force measurements 702) applied to the load cell 701 at a plurality of positions of the chuck 108 holding the sample block 105 (identified in the position measurements 605). In some embodiments, the controller 118 can cause the motor controller 604 to cause the motor 607 to move the chuck 108 holding the sample block 105 to one or more (e.g., three) unique positions (e.g., along the Y and Z axes). The controller 118 can be configured to identify, in the force measurements 702 received from the load cell 701, the force applied to the chuck 108 by the sample block 105. The controller 118 can identify mechanical force (e.g., Newtons) applied to the load cell 701 from electrical measurements in the force measurements 702.

In some embodiments, the controller 118 can cause the motor controller 604 to cause the motor 607 to move the chuck 108 around to detect and measure a baseline of expected forces on the chuck 108 during use to identify the increase in force. In some embodiments, the controller 118 can detect and measure the magnitude and phase shifts of the forces to determine a baseline or expected force to compare against during use to identify the increase in force. In some embodiments, the controller 118 can use an algorithm to compare deviation of peak frequencies to the baseline and decide based on those deviations whether an increase in force occurred.

In some embodiments, the controller 118 identifies a force spike 704 indicating that the force (identified from the force measurements 702) exceeded a predetermined threshold at the position (based on the position measurements 605) of the chuck 108. For example, if the face plane 107 is titled about the Y axis relative to the blade plane 112, the blade surface 111 would exert more force on the front face 106 and cause the sample block 105 to exert force on the load cell 701. In some examples, if the face plane 107 is tilted with respect to the blade plane 112 and the chuck 108 is advanced toward the blade surface 111 at different positions in the Y-Z plane, the contact force measurements (which may be the force spike 704) between the sample block 105 and blade 110 would be detected at different points of advancement of the chuck 108 along the X axis depending on the particular Y-Z positioning of the chuck 108. In some embodiments, the controller 118 can cause the motor controller 604 to stop the motor 607 and thus the sample block 105 responsive to identifying the force spike 704. Upon causing the motor 607 to stop, the controller 118 can record the position of the chuck 108 holding the sample block 105. In some embodiments, the controller 118 can identify a plurality of force spikes by moving the chuck 108 along the Y axis (e.g., side to side) or the Z axis (e.g., up and down). The controller 118 can be configured to receive or identify, from the position sensor 310, the positions (e.g., x, y, z coordinates) of the chuck 108 at each of the force spike.

The controller 118 can use the position measurements 605 and the force measurements 702 to identify or calculate the face plane 107 for comparison to the blade plane 112 to identify the orientation of the front face 106 with respect to the blade 110. In some embodiments, if the force measurements stay constant while the chuck 108 moves, then the face plane 107 is parallel relative to the blade plane 112. For example, if the force measurements stay constant across the different Y-Z positions of the chuck 108 while the chuck 108 moves toward the blade surface in the X direction (e.g. the force spike 704 is detected at the same point of advancement along the X axis for the various Y-Z positions of the chuck 108), the front face 106 is parallel with the blade surface 111. In some embodiments, if the front face 106 is tilted with respect to the blade plane 112 and the chuck 108 is advanced toward the blade surface 111 at different positions in the Y-Z plane, the contact force measurements (e.g. the force spike 704) between the sample block 105 and blade 110 would be detected at different points of advancement of the chuck 108 along the X axis depending on the particular Y-Z positioning of the chuck 108. For example, the controller 118 can identify the face plane 107 based on the position of the chuck 108 during three force spikes. If the three force spikes are associated with movements of the blade 110 along the Z axis, then the face plane 107 might be tilted with respect to the Z axis and the blade plane 112.

In some embodiments, the controller 118 can use the position measurements 605 and the force measurements 702 to detect whether there are protrusions on the front face 106 to identify whether the topography of the front face 106 is smooth. In some embodiments, if the force measurements stay constant (e.g., no relative force spikes) while the chuck 108 moves, the front face 106 is smooth. For example, if the force measurements stay constant across the different Y-Z positions of the chuck 108 while the chuck 108 moves toward the blade surface in the X direction (e.g. the force spike 704 is detected at the same point of advancement along the X axis for the various Y-Z positions of the chuck 108), the front face 106 may be smooth. In some embodiments, if the front face 106 includes bulges and the chuck 108 is advanced toward the blade surface 111 at different positions in the Y-Z plane, the contact force measurements (e.g. the force spike 704) between the sample block 105 and the blade 110 would be detected at different points of advancement of the chuck 108 along the X axis depending on the particular Y-Z positioning of the chuck 108 and contact of the bulges with the blade 110. For example, the controller 118 can identify whether there are protrusions on the front face 106 based on the position of the chuck 108 during three force spikes. If the three force spikes are associated with movements of the blade 110 along the Z axis, then the front face 106 might include bulges.

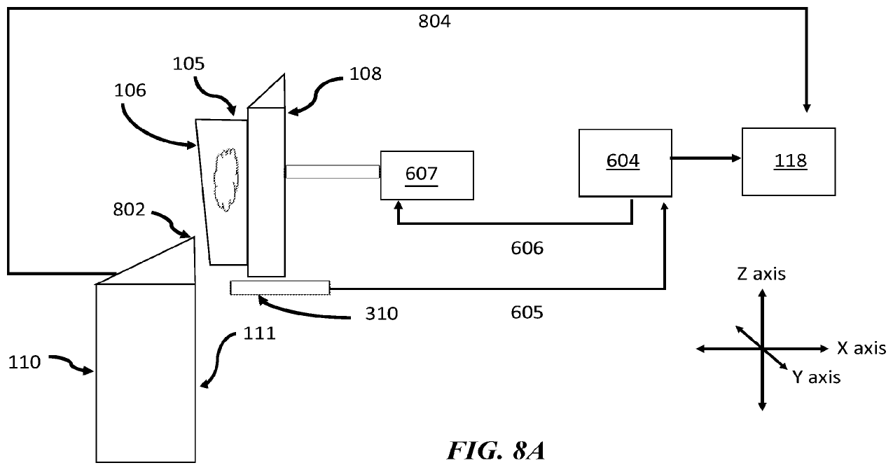

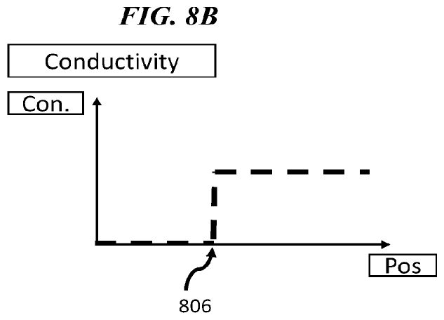

Now referring to FIGS. 8A and 8B, the surface sensor 116 can identify the geometry of the front face 106 based on conductivity of the blade surface 111 when it touches the front face 106. In some embodiments, the sample block 105 is non-conductive (e.g., sample block 105 can include paraffin) but when humidified, the front face 106 of the sample block 105 can include a layer of water, which is conductive. The blade surface 111 can include a conductivity sensor 802 configured to detect conductivity. The conductivity sensor 802 can detect a baseline conductivity when the blade surface 111 is not touching the front face 106. If the blade surface 111 touches the front face 106, the conductivity sensor 802 can detect an increase in conductivity due to the front face 106 being conductive. The position sensor 310 can record or identify the position of the chuck 108 when the conductivity increases. This detection can be repeated at various positions along the Y and Z axes. For example, if the face plane 107 is tilted about the Z axis or twisted about the Y axis, then the conductivity would increase as the chuck 108 moves the sample block 105 along the Z axis to cause the front face 106 to touch the blade surface 111. In another example, if the face plane 107 is tilted about the Z axis or twisted about the Y axis, then the conductivity would increase as the blade 110 moves along the Z axis to cause the front face 106 to touch the blade surface 111. In some examples, if the face plane 107 is tilted with respect to the blade plane 112 and the chuck 108 is advanced toward the blade surface 111 at different positions in the Y-Z plane, the conductivity measurements between the front face 106 and the blade surface 111 would be detected at different points of advancement of the chuck 108 along the X axis depending on the particular Y-Z positioning of the chuck 108. On the other hand, if the conductivity stays constant while the chuck 108 moves the sample block 105, the face plane 107 is parallel to the blade plane 112. In another example, if the conductivity stays constant while the blade 110 moves, the face plane 107 is parallel to the blade plane 112. In some examples, if the conductivity measurements stay constant across the different Y-Z positions of the chuck 108 while the chuck 108 moves toward the blade surface in the X direction (e.g. the conductivity spike is detected at the same point of advancement along the X axis for the various Y-Z positions of the chuck 108), the front face 106 may be parallel to the blade surface 111.

In some embodiments, the controller 118 can use the conductivity to detect whether there are protrusions on the front face 106 to identify whether the topography of the front face 106 is smooth. For example, if the front face 106 includes bulges, the conductivity would increase as the chuck 108 moves the sample block 105 along the Z axis to cause the bulges of the front face 106 to touch the blade surface 111. In some examples, if the front face 106 includes bulges, and the chuck 108 is advanced toward the blade surface 111 at different positions in the Y-Z plane, the conductivity measurements between the front face 106 and the blade surface 111 would be detected at different points of advancement of the chuck 108 along the X axis depending on the particular Y-Z positioning of the chuck 108 and contact of the bulges with the blade surface 111. On the other hand, if the conductivity stays constant while the chuck 108 is moved, the front face 106 is smooth. In some examples, if the conductivity measurements stay constant across the different Y-Z positions of the chuck 108 while the chuck 108 moves toward the blade surface in the X direction (e.g. the conductivity spike is detected at the same point of advancement along the X axis for the various Y-Z positions of the chuck 108), the front face 106 may be smooth.

In some embodiments, as shown in FIG. 8A, the system 100 can include the sample block 105, the blade 110, the position sensor 310, the controller 118, the motor controller 604, the motor 607, and a conductivity sensor 802 transmitting a conductivity measurements 804 to the controller 118.

The conductivity sensor 802 can be configured to measure voltage, current, resistance, or any other measurement of conductivity. The controller 118 can identify electrical measurements in the conductivity measurements 804 that indicates contact (e.g., voltage or current exceeding threshold, or resistance less than threshold) between the sample block 105 and blade 110. At the instant of contact, the controller 118 can identify the position of the chuck 108 from the position measurements 605 received by the motor controller 604 from the position sensor 310.

In some embodiments, as shown in FIG. 8A and FIG. 8B, the controller 118 can identify the conductivity (identified in the conductivity measurements 804) at a plurality of positions of the chuck 108 holding the sample block 105 (identified in the position measurements 605). The controller 118 can identify, in the conductivity measurements 804 received from the conductivity sensor 802, the conductivity measurements while moving the chuck 108. The controller 118 can identify conductivity parameters (e.g., voltage, resistance, current) in the conductivity measurements 804.

In some embodiments, the controller 118 can cause the motor controller 604 to cause the motor 607 to move the chuck 108 holding the sample block 105 to one or more (e.g., three) unique positions (e.g., along the Y and Z axes). In some embodiments, the controller 118 can cause the motor controller 604 to cause the motor 607 to move the chuck 108 around to detect and measure a baseline of expected conductivity. In some embodiments, the controller 118 can detect and measure the magnitude and phase shifts of the conductivity to determine a baseline or expected conductivity to compare against during use to identify the increase in conductivity. In some embodiments, the controller 118 can use an algorithm to compare deviation of peak frequencies to the baseline and decide based on those deviations whether an increase in conductivity occurred.

As shown in FIG. 8B, the controller 118 can identify a conductivity spike 806 indicating that the conductivity (identified from the conductivity measurements 804) exceeded a predetermined limit at a position of the chuck 108 (identified from the position measurements 605). For example, if the face plane 107 is tilted about the Y axis with respect to the blade plane 112 or includes bumps, the conductivity would increase when the front face 106 touches the blade surface 111. That is, in some examples, if the face plane 107 is tilted with respect to the blade plane 112 and the chuck 108 is advanced toward the blade surface 111 at different positions in the Y-Z plane, the conductivity measurements between the front face 106 and the blade surface 111 would be detected at different points of advancement of the chuck 108 along the X axis depending on the particular Y-Z positioning of the chuck 108. In some embodiments, the controller 118 can cause the motor controller 604 to stop the motor 607 and thus the sample block 105 responsive to identifying the conductivity spike 806. Upon causing the motor 607 to stop, the controller 118 can record the position of the chuck 108 holding the sample block 105. In some embodiments, the controller 118 can identify a plurality of conductivity spikes by moving the chuck 108 along the Y axis (e.g., side to side) or the Z axis (e.g., up and down) relative to the blade surface 111. The controller 118 can be configured to receive or identify, from the position sensor 310, the positions (e.g., x, y, z coordinates) of the chuck 108 at each of the conductivity spikes.

The controller 118 can use the position measurements 605 and the conductivity measurements 804 to identify or calculate the face plane 107. In some embodiments, if the face plane 107 is tilted about the Z axis or twisted about the Y axis, then the conductivity would increase as the blade 110 is moved along the Z axis to cause the front face 106 to touch the blade surface 111. Based on the position of the chuck 108 at each conductivity spike, the controller 118 can calculate the face plane 107 for comparison to the blade plane 112 and to identify the orientation of the front face 106 with respect to the blade surface 111. For example, the controller 118 can identify the face plane 107 based on the position of the chuck 108 during three conductivity spikes. If the three conductivity spikes are associated with movements of the blade 110 along the Z axis, then the face plane 107 might be tilted about the Y axis with respect to the blade plane 112. In some embodiments, if the conductivity stays constant while the chuck 108 is moved, the face plane 107 is parallel to the blade plane 112. For example, if the conductivity measurements stay constant across the different Y-Z positions of the chuck 108 while the chuck 108 moves toward the blade surface in the X direction (e.g. the conductivity spike is detected at the same point of advancement along the X axis for the various Y-Z positions of the chuck 108), the front face 106 may be parallel to the blade surface 111.

The controller 118 can use the position measurements 605 and the conductivity measurements 804 to identify whether there are protrusions on the front face 106 to identify whether the topography of the front face 106 is smooth. In some embodiments, if the front face 106 includes bulges, then the conductivity would increase as the blade 110 moves along the Z axis to cause the bulges of the front face 106 to touch the blade surface 111. In an example, if the front face 106 includes bulges, and the chuck 108 is advanced toward the blade surface 111 at different positions in the Y-Z plane, the conductivity measurements between the front face 106 and the blade surface 111 would be detected at different points of advancement of the chuck 108 along the X axis depending on the particular Y-Z positioning of the chuck 108 and contact of the bulges with the blade surface 111. In an example, the controller 118 can identify the face plane 107 based on the position of the chuck 108 during three conductivity spikes. If the three conductivity spikes are associated with movements of the blade 110 along the Z axis, then the front face 106 might include bulges. In some embodiments, if the conductivity stays constant while the chuck 108 is moved, then the front face 106 is smooth. In some examples, if the conductivity measurements stay constant across the different Y-Z positions of the chuck 108 while the chuck 108 moves toward the blade surface in the X direction (e.g. the conductivity spike is detected at the same point of advancement along the X axis for the various Y-Z positions of the chuck 108), the front face 106 may be smooth.

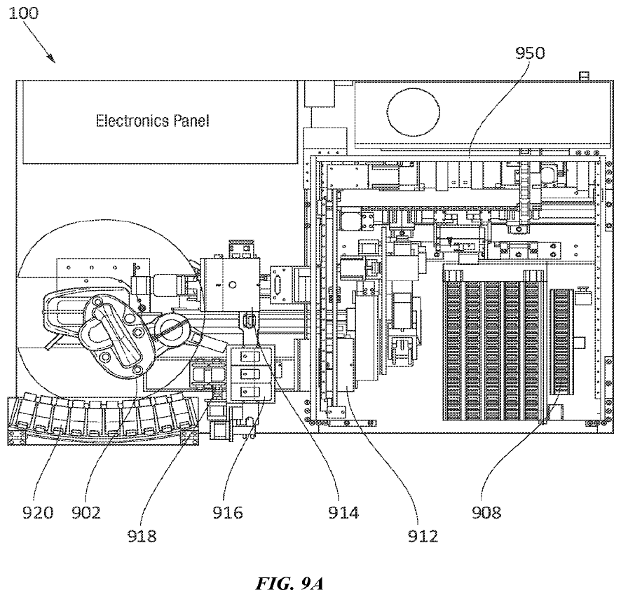

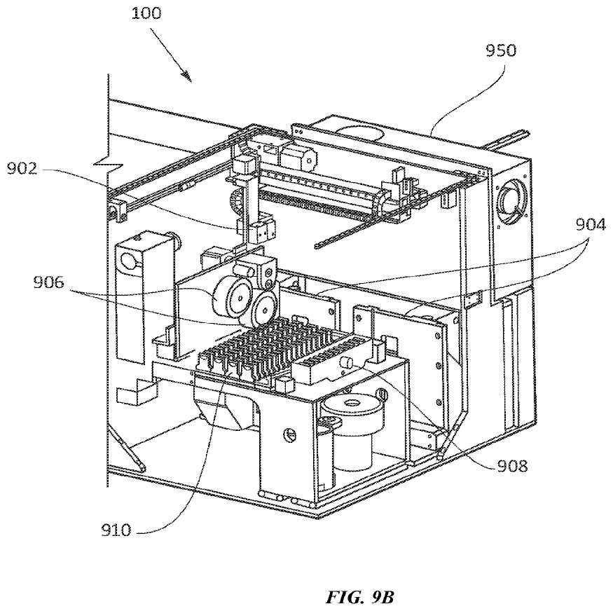

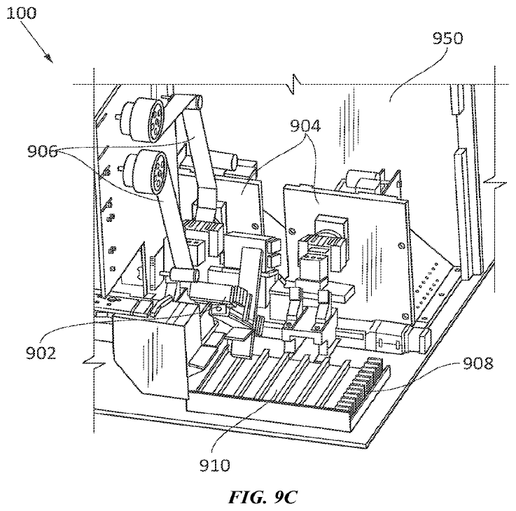

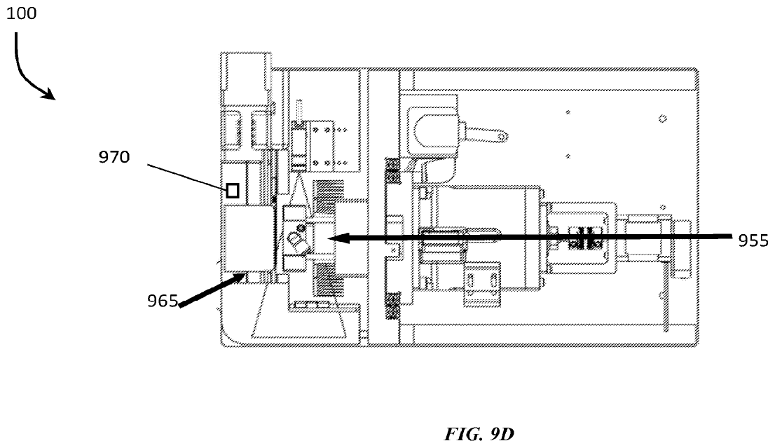

Referring to FIG. 9A, FIG. 9B, and FIG. 9C, in some embodiments, an automated pathology system 100 is provided for preparing tissue samples. Such systems can be configured for increased throughput during tissue sectioning. The system 100 can be designed to include a block handler 902, one or more microtomes 904, a transfer medium 906 (e.g., a tape), a hydration chamber 908, and a block tray 910. The block tray 910 can be a drawer like device designed to hold a plurality of sample blocks and can be placed into the system 100 for access by the block handler 902. The block tray 910 can have multiple rows each designed to hold one or more sample blocks and can have sufficient spacing such that the block handler 902 can index, grab, and remove one sample block at a time. In some embodiments, the block tray 910 can be designed to securely hold the sample blocks by using, for example, a spring-loaded mechanism, so that the sample block does not shift or fall out of the block tray 910 during handling. In some embodiments, the spring-loaded mechanism can further be designed such that the block handler 902 can pull the sample block 105 out without damaging or deforming them. For example, the pitch of the sample block within the block tray 910 can enable the block handler grippers of the block handler 902 to access the sample block 105 without interfering with adjacent blocks. The block handler 902 can include any combination of mechanisms capable of grasping or moving sample blocks in and out of a microtome 904, specifically, into a chuck of the microtome 904. For example, the block handler 902 can include a gantry, a push and pull actuator, a gripper on a Selective Compliance Assembly Robot Arm (SCARA) robot.

Referring to FIG. 9A, in some embodiments, the system 100 can include a combination of mechanisms to transfer a section cut from the sample block 105 onto the transfer medium 906 to be transferred to a slide for analysis. The combination of mechanisms can include a slide adhesive coater 912, a slide printer 914, slide input racks 916, a slide singulator that picks a slide from a stack of slides 918, and slide output racks 920. This combination of mechanisms works together to prepare the sample on the slide and prepare the slide itself.

In some embodiments, the one or more microtomes 904 can include any combination of microtome types known in the art, specifically, for precisely sectioning sample blocks 105. For example, the one or more microtomes 904 can be a rotary, cryomicrotome, ultramicrotome, vibrating, saw, laser, etc. based designs. In some embodiments, the one or more microtomes 904 can be designed to move the chuck up and down while also being able to move laterally (e.g., in a direction of the thickness of the sample block 105). The one or more microtomes 904 can include any combination of components for receiving and sectioning the sample block 105. For example, the one or more microtomes 904 can include a knife-block with a blade handler for holding a changeable knife blade and a specimen holding unit with a chuck 108 and a chuck adapter for holding the sample block 105.

The one or more microtomes 904 is configured to cut a tissue section from a tissue sample enclosed in a supporting block of preservation material such as paraffin wax. The one or more microtomes 904 can hold a blade aligned for cutting sections from one face of the sample block—the block cutting face or a block face. For example, a rotary microtome, can linearly oscillate a chuck holding the specimen block with the cutting face in the blade-cutting plane, which combined with incremental advancement of the block cutting face into the cutting plane, the microtome 904 can successively shave thin tissue sections off the block cutting face.

In operation, the one or more microtomes 904 is used to face or section sample blocks. When the sample block 105 is initially delivered to the one or more microtomes 904, the sample block can be faced. Facing is removing a layer of preservation material and exposing the large cross section of the tissue. That is, the preservation material with the tissue sample embedded in it can first be subjected to sectioning with relatively thick sections to remove the 0.1 mm-1 mm layer of paraffin wax on top of the tissue sample. When enough paraffin has been removed, and the complete outline of the tissue sample is exposed, the block is “faced”, and ready for acquisition of a processable section that can be put on a glass slide. For the facing process, the one or more microtomes 904 can shave off sections of the sample block 105 until an acceptable portion of the sample within the block is revealed. In some embodiments, the system can include one or more cameras to identify when an acceptable portion of the sample within the sample block 105 is revealed. For the cutting process, the one or more microtomes 904 can shave off a sample section of the sample block 105 with an acceptable thickness to be placed on a slide for analysis.

Once the sample block 105 is faced, in some embodiments, the faced sample blocks can be hydrated (for example, in a hydration chamber 908 or directly at the one or more microtomes) for a period of time in a hydrating fluid. In addition to being hydrated, the sample blocks 105 can be cooled. The cooling system can be part of the hydration chamber 908 or a separate component from the hydration chamber 908. In some embodiments, the cooling system can provide cooling to all the components within the sectioning chamber 950. The sectioning chamber 950 can provide insulation enclosing the one or more microtomes 904, the hydration chamber 908, the block tray 910, the blade and the blade exchanger of the microtome 904, and the cameras. This way there are minimal number of openings in the insulation, which can increase the efficiency and effectiveness within the sectioning chamber 950. Regardless of position, the cooling system can have a mini compressor, a heat exchanger, and an evaporator plate to create a cool surface. The air in the sectioning chamber can be pulled in and passed over the evaporator plate, for example, using fans. The cooled air can circulate in the sectioning chamber 950 or hydration chamber 908 to cool the paraffin sample blocks. The mass of equipment in the cooling chamber can provide a thermal inertia as well. Once the chamber is cooled, its temperature can be maintained more effectively, for example, if an access door is opened by the user to remove the block tray 910. In some embodiments, the temperature of the sample block 105 is maintained between 4° C. to 20° C. Keeping the sample blocks 105 cool can benefit the sectioning process as well as the hydration process.

Once the sample block 105 has been sufficiently hydrated, in some embodiments, it is ready for sectioning. Essentially, the one or more microtomes cuts thin sections of the tissue samples from the sample block 105. The tissue sections can then be picked up by the transfer medium 906, such as a tape, for subsequent transfer for placement on the slides. In some embodiments, depending on the microtome 904 setup of the system 100, the system 100 can include a single or multiple transfer medium 906 units. For example, in tandem operation, the transfer medium 906 can be associated with a polishing and sectioning microtome 904, whereas in a parallel operation, a separate transfer medium 906 can be associated with each microtome 904 within the system 100. In automated systems, each of these processes/steps of facing, hydration, sectioning, and transfer to slides are computer controlled rather than performed in the manual workflow by the histotechnician.

Referring back to FIG. 9A, FIG. 9B, and FIG. 9C, in some embodiment, the transfer medium 906 can be designed in a manner in which a tissue section cut from the tissue sample in the sample block 105 adheres and can then be transported by the moving transfer medium 906. For example, the transfer medium 906 can include any combination of materials designed to physically (e.g., electrostatic) or chemically adhere to the sample material. The transfer medium 906 can be designed to accommodate a large number of tissue sample sections cut from the sample block 105 to be transferred to slides to be included on slides for evaluation. In some embodiments, the transfer medium 906 can be replaced by a water channel to carry tissue. The system 100 can include any additional combination of features for use in an automated microtome design.

In some embodiments, the system 100 can follow a process to face, hydrate, section, and transport cut tissue sections to slides in an efficient automated fashion.

In some embodiments, the system 100, can predict the cut quality of a given sample block 105 based on one or more physical measurements using at least one sensor during the operation of the microtome. The prediction of the cut quality of the sample block 105 can be advantageous to prevent any damage to the tissue sections, in contrast to only adjusting the microtome or the chuck holding the sample block 105 after damage to the tissue is found. Further, by preemptively preventing departures from a baseline physical state, the automated system can infer tissue quality variations before they occur. Such a system can prevent unnecessary waste of tissue to allow for a more efficient use of the biopsied sample.

In some embodiments, as shown in FIG. 9D, the system 100 can include a chuck accelerometer 955 disposed on the chuck 108. The chuck accelerometer 955 can be provided to measure dynamic motion, or detect departures, in the vicinity of the motion side of the microtome. The departures in the vicinity of the motion can be indicative of a loose part in the chuck 108, or any other fastener in the local system. The loose parts in the chuck 108, or other fasteners in the local system, can create unwanted relative motion between the microtome and the sample, thereby degrading the cut quality of the overall system. In some embodiments, the chuck accelerometer 955 can additionally measure static states, or orientations, of the microtome to determine, for example, the relative orientation of the microtome to other structure within the system. The chuck accelerometer 955 can, in some embodiments, measure low frequency vibrations, DC vibrations, or zero order changes.

In some embodiments, a blade accelerometer 965 can be on the blade 110 to detect departures in the structural changes in the vicinity of the blade 110. The blade accelerometer 965 can be used in addition to the chuck accelerometer 955 or used alone. Depending on the position of the blade accelerometer 965, the stiffness of blade 110 and the clamping can be detected as well.

In some embodiments, the system can additionally, or alternatively, include a sensor which can be a temperature sensor 970. The temperature sensor 970 can be a thermocouple or an IR temperature measurement device that is pointed to the sample block 105 or another reference surface. In one example, if the temperature sensor 970 determines that the sample block 105 is reaching temperatures that exceed a predetermined maximum, the controller 118 may determine that the tissue is at risk of damage from heat and may alert the operator.

In addition to or instead of the sensors, the system may use additional sensors to measure the dynamics of the blade 110. The dynamics of the blade 110 can be how the microtome moves, including vibration level motion. The dynamics of the blade 110 can include vibration characteristics, such as acceleration magnitude and frequencies. In some embodiments, these additional sensors can be used independently from the chuck accelerometer 955, accelerometer 965, and the temperature sensor 970. In some embodiments, there are ways of measuring the dynamics of the microtome and the blade 110 without effecting the dynamics of the part that is being measured. For example, these sensors and methods may not change the stiffness or add mass to the system 100.

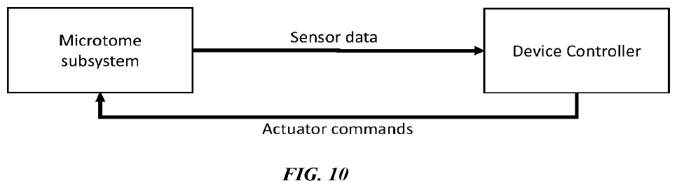

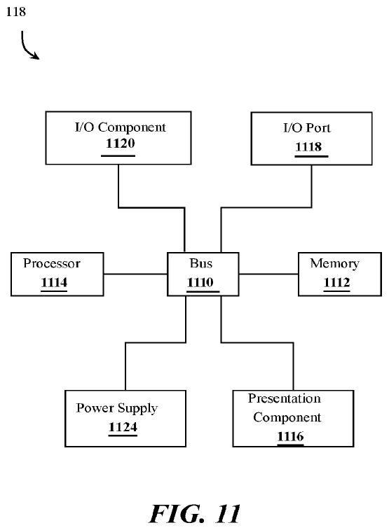

The instant system 100 can function with a closed loop control and health monitoring system, as shown in FIG. 10. Such a system 100 can take input data from the plurality of sensors, discussed above, and input them into a device control computer, for example, controller 118 as shown in FIG. 11. A control and decision algorithm running, or a non-transitory computer readable medium, can run on the controller 118 to fuse the sensor data to decide on the health and cut quality of the microtome. The control system controls the actuators to compensate for any sensed deteriorations in the microtome performance. The system can, additionally or alternatively, warn a user if the self-correction is not sufficient.

The system 100 can additionally, or alternatively, include post sectioning quality detection. For example, when a section is taken on tape, in an ongoing fashion, the undulations and other periodic marks are searched on the image of the section. Existence of such marks may indicate a loose part or deterioration in the sectioning quality. In addition, one can measure the thickness of the section on tape to determine section to section variations and relate these to structural integrity of the microtome. For example, a camera, as seen generally in the lateral camera 405 and longitudinal camera 410, can point to a section on tape or glass to determine the source of tissue quality deviations. Additionally, the camera can include a dedicated illumination system that can provide illumination on demand at various predetermined wavelengths. In some examples, tissue quality deviations can be determined using quality control algorithms, such as those disclosed in commonly owned U.S. application Ser. No. 17/451,870, entitled “FACING AND QUALITY CONTROL IN MICROTOMY,” incorporated by reference in its entirety herein. Those quality control algorithms can compare a first imaging data, or a baseline image, to a second imaging data, obtained after a cut, to confirm correspondence in the tissue sample in the first imaging data and the second imaging data based on one or more quality control parameters to determine deviations or quality control issues in the cut quality or microtome.

While embodiments have been discussed herein particularly focused on moving the chuck and sample block relative the blade to align the front face of the sample block with the blade surface of the blade, it should be appreciated that the blade can be moved in addition to or instead of the chuck and sample block to align the front face of the sample block with the blade surface of the blade. For instance, the microtome can be configured to move the blade in any number of degrees of freedom to align the blade surface of the blade with the front face of the sample block.

Any suitable computing device can be used to implement the computing devices and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a controller 118 is depicted in FIG. 11. The controller 118 is merely an illustrative example of a suitable computing environment and in no way limits the scope of the present disclosure. A “computing device,” as represented by FIG. 11, can include a “workstation,” a “server,” a “laptop,” a “desktop,” a “hand-held device,” a “mobile device,” a “tablet computer,” or other computing devices, as would be understood by those of skill in the art. Given that the controller 118 is depicted for illustrative purposes, embodiments of the present disclosure may utilize any number of controllers 118 in any number of different ways to implement a single embodiment of the present disclosure. Accordingly, embodiments of the present disclosure are not limited to a single controller 118, as would be appreciated by one with skill in the art, nor are they limited to a single type of implementation or configuration of the example controller 118.

The controller 118 can include a bus 1110 that can be coupled to one or more of the following illustrative components, directly or indirectly: a memory 1112, one or more processors 1114, one or more presentation components 1116, input/output ports 1118, input/output components 1120, and a power supply 1124. One of skill in the art will appreciate that the bus 1110 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 11 is merely illustrative of an exemplary computing device that can be used to implement one or more embodiments of the present disclosure, and in no way limits the disclosure.

The controller 118 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the controller 118.

The memory 1112 can include computer-storage media in the form of volatile or nonvolatile memory. The memory 1112 may be removable, non-removable, or any combination thereof. Exemplary hardware devices are devices such as hard drives, solid-state memory, optical-disc drives, and the like. The controller 118 can include one or more processors that read data from components such as the memory 1112, the various I/O components 1116, etc. Presentation component(s) 1116 present data indications to a user or other device. Exemplary presentation components include a display device, speaker, printing component, vibrating component, etc.

The I/O ports 1118 can enable the controller 118 to be logically coupled to other devices, such as I/O components 1120. Some of the I/O components 1120 can be built into the controller 118. Examples of such I/O components 1120 include a microphone, joystick, recording device, game pad, satellite dish, scanner, printer, wireless device, networking device, and the like.

Non-limiting embodiments of the present disclosure are set out in the following clauses:
1. A system comprising: a chuck configured to accept a sample block; a blade comprising a blade surface configured to remove a tissue section from the sample block, wherein the chuck is moveable relative to the blade surface of the blade; at least one sensor configured to sense a front face of the sample block; and a control system configured to: receive measurements from the at least one sensor; identify, from the measurements, a geometry of the front face; identify, based on the geometry, an alignment of the front face with respect to the blade surface of the blade; and cause the chuck or the blade to move relative to each other to align the front face relative to the blade surface.
2. The system of clause 1, wherein the at least one sensor is stationary.
3. The system of clause 1 or clause 2, wherein the control system is further configured to cause the chuck or the blade to move relative to each other to section the sample block.
4. The system of any one of clauses 1-3, wherein the control system is configured to cause the chuck or the blade to move relative to each other to section the sample block after aligning the front face relative to the blade surface.
5. The system of any one of clauses 1-4, wherein the chuck is configured to move along a first degree of freedom and a second degree of freedom, wherein the first degree of freedom is along an X axis to align the front face relative to the blade surface and the second degree of freedom is along a Z axis to enable the blade to section the sample block.
6. The system of any one of clauses 1-5, wherein the chuck is configured to move along three degrees of freedom.
7. The system of any one of clauses 1-6, wherein the blade and the at least one sensor are stationary relative to one another.
8. The system of any one of clauses 1-7, wherein identifying the geometry comprises identifying, from the measurements, an orientation of the front face relative to the blade surface.
9. The system of any one of clauses 1-8, wherein identifying the geometry comprises identifying, from the measurements, a topography of the front face.
10. The system of any one of clauses 1-9, wherein identifying the geometry comprises: identifying, from the measurements, an orientation of the front face relative to the blade surface; and identifying, from the measurements, a topography of the front face.
11. The system of any one of clauses 1-10, wherein the at least one sensor is an axial sensor configured to sense a distance between the axial sensor and the front face at a plurality of positions of the sample block.
12. The system of any one of clauses 1-11, wherein the at least one sensor is a plurality of axial sensors configured to each sense a respective distance to the front face.
13. The system of any one of clauses 1-12, wherein the at least one sensor is a lateral sensor configured to sense an intersection between a signal generated by the lateral sensor and the front face at a plurality of positions of the sample block.
14. The system of any one of clauses 1-13, wherein the at least one sensor is a plurality of lateral sensors configured to each sense an intersection between a signal generated by a respective lateral sensor and the front face.
15. The system of any one of clauses 1-14, wherein the at least one sensor is a plurality of cameras configured to each capture one or more images of the front face.
16. The system of any one of clauses 1-15, wherein the at least one sensor is a plurality of sensors configured to generate a measurement grid and detect a plurality of intersections between the measurement grid and the front face.
17. The system of any one of clauses 1-16, wherein the at least one sensor is a position sensor and a motor sensor, the position sensor configured to identify a plurality of positions of the chuck holding the sample block, the motor sensor configured to identify power usage of a motor moving the chuck at each of the plurality of positions.
18. The system of any one of clauses 1-17, wherein the at least one sensor is a position sensor and a force sensor, the position sensor configured to identify a plurality of positions of the chuck holding the sample block, the force sensor configured to identify a force between the front face and the blade surface at each of the plurality of positions.
19. The system of any one of clauses 1-18, wherein the at least one sensor is a position sensor and a conductivity sensor, the position sensor configured to identify a plurality of positions of the chuck holding the sample block, the conductivity sensor configured to identify conductivity at the blade surface at each of the plurality of positions of the chuck holding the sample block.
20. The system of any one of clauses 1-19, wherein causing the chuck or the blade to move relative to each other to align the front face relative to the blade surface comprises positioning the front face parallel to the blade surface.
21. The system of any one of clauses 1-20, wherein causing the chuck or the blade to move relative to each other to align the front face relative to the blade surface comprises shaving one or more protrusions from the front face to smooth the front face.
22. The system of any one of clauses 1-21, wherein causing the chuck or the blade to move relative to each other to align the front face relative to the blade surface comprises: shaving one or more protrusions from the front face to smooth the front face; and positioning the front face parallel to the blade surface.
23. The system of any one of clauses 1-22, wherein identifying, based on the geometry, the alignment of the front face with respect to the blade surface comprises determining whether the alignment exceeds a pre-determined threshold value or is outside of a nominal range.
24. The system of any one of clauses 1-23, wherein the control system is further configured to output an alert to a user to manually correct the alignment of the front face relative to the blade surface.
25. A system comprising: at least one sensor configured to sense data regarding an alignment of a front face of a sample block and a blade surface of a blade configured to remove a tissue section from the sample block; and a controller in communication with the at least one sensor and configured to: receive data from the at least one sensor; identify, from the data, a geometry of the front face; identify, based on the geometry, the alignment of the front face with respect to the blade surface of the blade; and cause a chuck holding the sample block or the blade to move relative to each other to align the front face relative to the blade surface.
26. The system of clause 25, wherein the at least one sensor is stationary.
27. The system of clause 25 or clause 26, wherein the controller is further configured to cause the chuck or the blade to move relative to each other to section the sample block.
28. The system of any one of clauses 25-27, wherein the controller is further configured to cause the chuck or the blade to move relative to each other to section the sample block after aligning the front face relative to the blade surface.
29. The system of any one of clauses 25-28, wherein the chuck is configured to move along a first degree of freedom and a second degree of freedom, wherein the first degree of freedom is along an X axis to align the front face relative to the blade surface and the second degree of freedom is along a Z axis to enable the blade to section the sample block.
30. The system of any one of clauses 25-29, wherein the chuck is configured to move along three degrees of freedom.
31. The system of any one of clauses 25-30, wherein the blade and the at least one sensor are stationary relative to one another.
32. The system of any one of clauses 25-31, wherein identifying the geometry comprises identifying, from the data, an orientation of the front face relative to the blade surface.
33. The system of any one of clauses 25-32, wherein identifying the geometry comprises identifying, from the data, a topography of the front face.
34. The system of any one of clauses 25-33, wherein identifying the geometry comprises: identifying, from the data, an orientation of the front face relative to the blade surface; and identifying, from the data, a topography of the front face.
35. The system of any one of clauses 25-34, wherein the at least one sensor is an axial sensor configured to sense a distance between the axial sensor and the front face at a plurality of positions of the sample block.
36. The system of any one of clauses 25-35, wherein the at least one sensor is a plurality of axial sensors configured to each sense a respective distance to the front face.
37. The system of any one of clauses 25-36, wherein the at least one sensor is a lateral sensor configured to sense an intersection between a signal generated by the lateral sensor and the front face at a plurality of positions of the sample block.
38. The system of any one of clauses 25-37, wherein the at least one sensor is a plurality of lateral sensors configured to each sense an intersection between a signal generated by a respective lateral sensor and the front face.
39. The system of any one of clauses 25-38, wherein the at least one sensor is a plurality of cameras configured to each capture one or more images of the front face.
40. The system of any one of clauses 25-39, wherein the at least one sensor is a plurality of sensors configured to generate a measurement grid and detect a plurality of intersections between the measurement grid and the front face.
41. The system of any one of clauses 25-40, wherein the at least one sensor is a position sensor and a motor sensor, the position sensor configured to identify a plurality of positions of the chuck holding the sample block, the motor sensor configured to identify power usage of a motor moving the chuck at each of the plurality of positions.
42. The system of any one of clauses 25-41, wherein the at least one sensor is a position sensor and a force sensor, the position sensor configured to identify a plurality of positions of the chuck holding the sample block, the force sensor configured to identify a force between the front face and the blade surface at each of the plurality of positions.
43. The system of any one of clauses 25-42, wherein the at least one sensor is a position sensor and a conductivity sensor, the position sensor configured to identify a plurality of positions of the chuck holding the sample block, the conductivity sensor configured to identify conductivity at the blade surface at each of the plurality of positions of the chuck holding the sample block.
44. The system of any one of clauses 25-43, wherein causing the chuck or the blade to move relative to each other to align the front face relative to the blade surface comprises positioning the front face parallel to the blade surface.
45. The system of any one of clauses 25-44, wherein causing the chuck or the blade to move relative to each other to align the front face relative to the blade surface comprises shaving one or more protrusions from the front face to smooth the front face.
46. The system of any one of clauses 25-45, wherein causing the chuck or the blade to move relative to each other to align the front face relative to the blade surface comprises: shaving one or more protrusions from the front face to smooth the front face; and positioning the front face parallel to the blade surface.
47. The system of any one of clauses 25-46, wherein identifying, based on the geometry, the alignment of the front face with respect to the blade surface comprises determining whether the alignment exceeds a pre-determined threshold value or is outside of a nominal range.
48. The system of any one of clauses 25-47, wherein the controller is further configured to output an alert to a user to manually correct the alignment of the front face relative to the blade surface.
49. A method comprising: sensing, with at least one sensor, data regarding a front face of a sample block, wherein the sample block is received within a chuck, and wherein the chuck is moveable relative to a blade surface of a blade configured to remove a tissue section from the sample block; sending, by the at least one sensor, the sensed data to a controller; identifying, by the controller and from the sensed data, a geometry of the front face; identifying, by the controller and based on the geometry, an alignment of the front face with respect to the blade surface of the blade; and causing the chuck or the blade to move relative to each other to align the front face relative to the blade surface.
50. The method of clause 49, further comprising causing, by the controller, the chuck or the blade to move relative to each other to section the sample block.
51. The method of clause 49 or clause 50, further comprising, causing, by the controller, the chuck or the blade to move relative to each other to section the sample block after aligning the front face relative to the blade surface.
52. The method of any one of clauses 49-51, wherein identifying the geometry comprises identifying, from the sensed data, an orientation of the front face relative to the blade surface.
53. The method of any one of clauses 49-52, wherein identifying the geometry comprises identifying, from the sensed data, a topography of the front face.
54. The method of any one of clauses 49-53, wherein identifying the geometry comprises: identifying, from the sensed data, an orientation of the front face relative to the blade surface; and identifying, from the sensed data, a topography of the front face.
55. The method of any one of clauses 49-54, wherein the at least one sensor is an axial sensor, and wherein sensing the data regarding the front face comprises sensing a distance between the axial sensor and the front face at a plurality of positions of the sample block.
56. The method of any one of clauses 49-55, wherein the at least one sensor is a plurality of axial sensors, and wherein sensing the data regarding the front face comprises sensing a respective distance between the plurality of axial sensors and the front face.
57. The method of any one of clauses 49-56, wherein the at least one sensor is a lateral sensor, and wherein sensing the data regarding the front face comprises sensing an intersection between a signal generated by the lateral sensor and the front face at a plurality of positions of the sample block.
58. The method of any one of clauses 49-57, wherein the at least one sensor is a plurality of lateral sensors, and wherein sensing the data regarding the front face comprises sensing a respective intersection between a respective signal generated by the plurality of lateral sensors and the front face.
59. The method of any one of clauses 49-58, wherein the at least one sensor is a plurality of cameras, and wherein sensing the data regarding the front face comprises capturing one or more images of the front face with the plurality of cameras.
60. The method of any one of clauses 49-59, wherein the at least one sensor is a plurality of sensors, and wherein sensing the data regarding the front face comprises generating a measurement grid and detecting a plurality of intersections between the measurement grid and the front face with the plurality of sensors.
61. The method of any one of clauses 49-60, wherein the at least one sensor is a position sensor and a motor sensor, and wherein sensing the data regarding the front face comprises: identifying, with the position sensor, a plurality of positions of the chuck holding the sample block; and identifying, with the motor sensor, power usage of a motor moving the chuck at each of the plurality of positions.
62. The method of any one of clauses 49-61, wherein the at least one sensor is a position sensor and a force sensor, and wherein sensing the data regarding the front face comprises: identifying, with the position sensor, a plurality of positions of the chuck holding the sample block; an identifying, with the force sensor, a force between the front face and the blade surface at each of the plurality of positions.
63. The method of any one of clauses 49-62, wherein the at least one sensor is a position sensor and a conductivity sensor, and wherein sensing the data regarding the front face comprises: identifying, with the position sensor, a plurality of positions of the chuck holding the sample block; and identifying, with the conductivity sensor, conductivity at the blade surface at each of the plurality of positions of the chuck holding the sample block.
64. The method of any one of clauses 49-63, wherein causing the chuck or the blade to move relative to each other to align the front face relative to the blade surface comprises positioning the front face parallel to the blade surface.
65. The method of any one of clauses 49-64, wherein causing the chuck or the blade to move relative to each other to align the front face relative to the blade surface comprises shaving one or more protrusions from the front face to smooth the front face.
66. The method of any one of clauses 49-65, wherein causing the chuck or the blade to move relative to each other to align the front face relative to the blade surface comprises: shaving one or more protrusions from the front face to smooth the front face; and positioning the front face parallel to the blade surface.
67. The method of any one of clauses 49-66, wherein identifying, from the sensed data, the alignment of the front face with respect to the blade surface comprises determining whether the alignment exceeds a pre-determined threshold value or is outside of a nominal range.
68. The method of any one of clauses 49-67, further comprising, outputting, by the controller, an alert to a user to manually correct the alignment of the front face relative to the blade surface.
69. A method comprising: receiving, by a controller, data sensed with at least one sensor, wherein the data relates to an alignment of a front face of a sample block received in a chuck and a blade surface of a blade configured to remove a tissue section from the sample block; identifying, by the controller and from the data, a geometry of the front face; identifying, by the controller and based on the geometry, the alignment of the front face with respect to the blade surface of the blade; and causing the chuck or the blade to move relative to each other to align the front face relative to the blade surface.
70. The method of clause 69, further comprising causing, by the controller, the chuck or the blade to move relative to each other to section the sample block.
71. The method of clause 69 or clause 70, further comprising causing, by the controller, the chuck or the blade to move relative to each other to section the sample block after aligning the front face relative to the blade surface.
72. The method of any one of clauses 69-71, wherein identifying the geometry comprises identifying, from the data, an orientation of the front face relative to the blade surface.
73. The method of any one of clauses 69-72, wherein identifying the geometry comprises identifying, from the data, a topography of the front face.
74. The method of any one of clauses 69-73, wherein identifying the geometry comprises: identifying, from the data, an orientation of the front face relative to the blade surface; and identifying, from the data, a topography of the front face.
75. The method of any one of clauses 69-74, wherein causing the chuck or the blade to move relative to each other to align the front face relative to the blade surface comprises positioning the front face parallel to the blade surface.
76. The method of any one of clauses 69-75, wherein causing the chuck or the blade to move relative to each other to align the front face relative to the blade surface comprises shaving one or more protrusions from the front face to smooth the front face.
77. The method of any one of clauses 69-76, wherein causing the chuck or the blade to move relative to each other to align the front face relative to the blade surface comprises: shaving one or more protrusions from the front face to smooth the front face; and positioning the front face parallel to the blade surface.
78. The method of any one of clauses 69-77, wherein identifying, from the data, the alignment of the front face with respect to the blade surface comprises determining whether the alignment exceeds a pre-determined threshold value or is outside of a nominal range.
79. The method of any one of clauses 69-78, further comprising outputting, by the controller, an alert to a user to manually correct the alignment of the front face relative to the blade surface.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification, embodiments have been described in a way which enables a clear and concise specification to be written, but it is intended and will be appreciated that embodiments may be variously combined or separated without parting from the scope of the present disclosure. It is intended that the present disclosure be limited only to the extent required by the appended claims and the applicable rules of law.

As utilized herein, the terms “comprise” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art. The use of the terminology X “or” Y herein should be interpreted as meaning either “X” or “Y” individually, or both “X and Y” together.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the disclosure. It is intended that the present disclosure be limited only to the extent required by the appended claims and the applicable rules of law.

It is also to be understood that the following claims are to cover all generic and specific features of the disclosure described herein, and all statements of the scope of the disclosure which, as a matter of language, might be said to fall therebetween.

What is claimed is:

1. A system comprising:
a chuck configured to accept a sample block;
a blade comprising a blade surface configured to remove a tissue section from the sample block, wherein the chuck is moveable relative to the blade surface of the blade;
at least one sensor configured to sense a front face of the sample block; and
a control system configured to:
receive measurements from the at least one sensor;
identify, from the measurements, a geometry of the front face;
identify, based on the geometry, an alignment of the front face with respect to the blade surface of the blade; and
cause the chuck or the blade to move relative to each other to align the front face relative to the blade surface.

2. The system of claim 1, wherein the at least one sensor is stationary.

3. The system of claim 1 or claim 2, wherein the control system is further configured to cause the chuck or the blade to move relative to each other to section the sample block.

4. The system of claim 3, wherein the control system is configured to cause the chuck or the blade to move relative to each other to section the sample block after aligning the front face relative to the blade surface.

5. The system of claim 1, wherein the chuck is configured to move along a first degree of freedom and a second degree of freedom, wherein the first degree of freedom is along an X axis to align the front face relative to the blade surface and the second degree of freedom is along a Z axis to enable the blade to section the sample block.

6. The system of claim 1, wherein the chuck is configured to move along three degrees of freedom.

7. The system of claim 1, wherein the blade and the at least one sensor are stationary relative to one another.

8. The system of claim 1, wherein identifying the geometry comprises identifying, from the measurements, an orientation of the front face relative to the blade surface.

9. The system of claim 1, wherein identifying the geometry comprises identifying, from the measurements, a topography of the front face.

10. The system of claim 1, wherein identifying the geometry comprises:
identifying, from the measurements, an orientation of the front face relative to the blade surface; and
identifying, from the measurements, a topography of the front face.

11. The system of claim 1, wherein the at least one sensor is an axial sensor configured to sense a distance between the axial sensor and the front face at a plurality of positions of the sample block.

12. The system of claim 1, wherein the at least one sensor is a plurality of axial sensors configured to each sense a respective distance to the front face.

13. The system of claim 1, wherein the at least one sensor is a lateral sensor configured to sense an intersection between a signal generated by the lateral sensor and the front face at a plurality of positions of the sample block.

14. The system of claim 1, wherein the at least one sensor is a plurality of lateral sensors configured to each sense an intersection between a signal generated by a respective lateral sensor and the front face.

15. The system of claim 1, wherein the at least one sensor is a plurality of cameras configured to each capture one or more images of the front face.

16. The system of claim 1, wherein the at least one sensor is a plurality of sensors configured to generate a measurement grid and detect a plurality of intersections between the measurement grid and the front face.

17. The system of claim 1, wherein the at least one sensor is a position sensor and a motor sensor, the position sensor configured to identify a plurality of positions of the chuck holding the sample block, the motor sensor configured to identify power usage of a motor moving the chuck at each of the plurality of positions.

18. The system of claim 1, wherein the at least one sensor is a position sensor and a force sensor, the position sensor configured to identify a plurality of positions of the chuck holding the sample block, the force sensor configured to identify a force between the front face and the blade surface at each of the plurality of positions.

19. The system of claim 1, wherein the at least one sensor is a position sensor and a conductivity sensor, the position sensor configured to identify a plurality of positions of the chuck holding the sample block, the conductivity sensor configured to identify conductivity at the blade surface at each of the plurality of positions of the chuck holding the sample block.

20. The system of claim 1, wherein causing the chuck or the blade to move relative to each other to align the front face relative to the blade surface comprises positioning the front face parallel to the blade surface.

21. The system of claim 1, wherein causing the chuck or the blade to move relative to each other to align the front face relative to the blade surface comprises shaving one or more protrusions from the front face to smooth the front face.

22. The system of claim 1, wherein causing the chuck or the blade to move relative to each other to align the front face relative to the blade surface comprises:
shaving one or more protrusions from the front face to smooth the front face; and
positioning the front face parallel to the blade surface.

23. The system of claim 1, wherein identifying, based on the geometry, the alignment of the front face with respect to the blade surface comprises determining whether the alignment exceeds a pre-determined threshold value or is outside of a nominal range.

24. The system of claim 1, wherein the control system is further configured to output an alert to a user to manually correct the alignment of the front face relative to the blade surface.

25. A system comprising:
at least one sensor configured to sense data regarding an alignment of a front face of a sample block and a blade surface of a blade configured to remove a tissue section from the sample block; and
a controller in communication with the at least one sensor and configured to:
receive data from the at least one sensor;
identify, from the data, a geometry of the front face;
identify, based on the geometry, the alignment of the front face with respect to the blade surface of the blade; and
cause a chuck holding the sample block or the blade to move relative to each other to align the front face relative to the blade surface.

26. The system of claim 25, wherein the at least one sensor is stationary.

27. The system of claim 25 or claim 26, wherein the controller is further configured to cause the chuck or the blade to move relative to each other to section the sample block.

28. The system of claim 25, wherein the controller is further configured to cause the chuck or the blade to move relative to each other to section the sample block after aligning the front face relative to the blade surface.

29. The system of claim 25, wherein the chuck is configured to move along a first degree of freedom and a second degree of freedom, wherein the first degree of freedom is along an X axis to align the front face relative to the blade surface and the second degree of freedom is along a Z axis to enable the blade to section the sample block.

30. The system of claim 25, wherein the chuck is configured to move along three degrees of freedom.

31. The system of claim 25, wherein the blade and the at least one sensor are stationary relative to one another.

32. The system of claim 25, wherein identifying the geometry comprises identifying, from the data, an orientation of the front face relative to the blade surface.

33. The system of claim 25, wherein identifying the geometry comprises identifying, from the data, a topography of the front face.

34. The system of claim 25, wherein identifying the geometry comprises:
identifying, from the data, an orientation of the front face relative to the blade surface; and
identifying, from the data, a topography of the front face.

35. The system of claim 25, wherein the at least one sensor is an axial sensor configured to sense a distance between the axial sensor and the front face at a plurality of positions of the sample block.

36. The system of claim 25, wherein the at least one sensor is a plurality of axial sensors configured to each sense a respective distance to the front face.

37. The system of claim 25, wherein the at least one sensor is a lateral sensor configured to sense an intersection between a signal generated by the lateral sensor and the front face at a plurality of positions of the sample block.

38. The system of claim 25, wherein the at least one sensor is a plurality of lateral sensors configured to each sense an intersection between a signal generated by a respective lateral sensor and the front face.

39. The system of claim 25, wherein the at least one sensor is a plurality of cameras configured to each capture one or more images of the front face.

40. The system of claim 25, wherein the at least one sensor is a plurality of sensors configured to generate a measurement grid and detect a plurality of intersections between the measurement grid and the front face.

41. The system of claim 25, wherein the at least one sensor is a position sensor and a motor sensor, the position sensor configured to identify a plurality of positions of the chuck holding the sample block, the motor sensor configured to identify power usage of a motor moving the chuck at each of the plurality of positions.

42. The system of claim 25, wherein the at least one sensor is a position sensor and a force sensor, the position sensor configured to identify a plurality of positions of the chuck holding the sample block, the force sensor configured to identify a force between the front face and the blade surface at each of the plurality of positions.

43. The system of claim 25, wherein the at least one sensor is a position sensor and a conductivity sensor, the position sensor configured to identify a plurality of positions of the chuck holding the sample block, the conductivity sensor configured to identify conductivity at the blade surface at each of the plurality of positions of the chuck holding the sample block.

44. The system of claim 25, wherein causing the chuck or the blade to move relative to each other to align the front face relative to the blade surface comprises positioning the front face parallel to the blade surface.

45. The system of claim 25, wherein causing the chuck or the blade to move relative to each other to align the front face relative to the blade surface comprises shaving one or more protrusions from the front face to smooth the front face.

46. The system of claim 25, wherein causing the chuck or the blade to move relative to each other to align the front face relative to the blade surface comprises:
shaving one or more protrusions from the front face to smooth the front face; and
positioning the front face parallel to the blade surface.

47. The system of claim 25, wherein identifying, based on the geometry, the alignment of the front face with respect to the blade surface comprises determining whether the alignment exceeds a pre-determined threshold value or is outside of a nominal range.

48. The system of claim 25, wherein the controller is further configured to output an alert to a user to manually correct the alignment of the front face relative to the blade surface.

49. A method comprising:
sensing, with at least one sensor, data regarding a front face of a sample block, wherein the sample block is received within a chuck, and wherein the chuck is moveable relative to a blade surface of a blade configured to remove a tissue section from the sample block;
sending, by the at least one sensor, the sensed data to a controller;
identifying, by the controller and from the sensed data, a geometry of the front face;
identifying, by the controller and based on the geometry, an alignment of the front face with respect to the blade surface of the blade; and
causing the chuck or the blade to move relative to each other to align the front face relative to the blade surface.

50. The method of claim 49, further comprising causing, by the controller, the chuck or the blade to move relative to each other to section the sample block.

51. The method of claim 49, further comprising causing, by the controller, the chuck or the blade to move relative to each other to section the sample block after aligning the front face relative to the blade surface.

52. The method of claim 49, wherein identifying the geometry comprises identifying, from the sensed data, an orientation of the front face relative to the blade surface.

53. The method of claim 49, wherein identifying the geometry comprises identifying, from the sensed data, a topography of the front face.

54. The method of claim 49, wherein identifying the geometry comprises:
identifying, from the sensed data, an orientation of the front face relative to the blade surface; and
identifying, from the sensed data, a topography of the front face.

55. The method of claim 49, wherein the at least one sensor is an axial sensor, and wherein sensing the data regarding the front face comprises sensing a distance between the axial sensor and the front face at a plurality of positions of the sample block.

56. The method of claim 49, wherein the at least one sensor is a plurality of axial sensors, and wherein sensing the data regarding the front face comprises sensing a respective distance between the plurality of axial sensors and the front face.

57. The method of claim 49, wherein the at least one sensor is a lateral sensor, and wherein sensing the data regarding the front face comprises sensing an intersection between a signal generated by the lateral sensor and the front face at a plurality of positions of the sample block.

58. The method of claim 49, wherein the at least one sensor is a plurality of lateral sensors, and wherein sensing the data regarding the front face comprises sensing a respective intersection between a respective signal generated by the plurality of lateral sensors and the front face.

59. The method of claim 49, wherein the at least one sensor is a plurality of cameras, and wherein sensing the data regarding the front face comprises capturing one or more images of the front face with the plurality of cameras.

60. The method of claim 49, wherein the at least one sensor is a plurality of sensors, and wherein sensing the data regarding the front face comprises generating a measurement grid and detecting a plurality of intersections between the measurement grid and the front face with the plurality of sensors.

61. The method of claim 49, wherein the at least one sensor is a position sensor and a motor sensor, and wherein sensing the data regarding the front face comprises:
identifying, with the position sensor, a plurality of positions of the chuck holding the sample block; and
identifying, with the motor sensor, power usage of a motor moving the chuck at each of the plurality of positions.

62. The method of claim 49, wherein the at least one sensor is a position sensor and a force sensor, and wherein sensing the data regarding the front face comprises:
identifying, with the position sensor, a plurality of positions of the chuck holding the sample block; and
identifying, with the force sensor, a force between the front face and the blade surface at each of the plurality of positions.

63. The method of claim 49, wherein the at least one sensor is a position sensor and a conductivity sensor, and wherein sensing the data regarding the front face comprises:
identifying, with the position sensor, a plurality of positions of the chuck holding the sample block; and
identifying, with the conductivity sensor, conductivity at the blade surface at each of the plurality of positions of the chuck holding the sample block.

64. The method of claim 49, wherein causing the chuck or the blade to move relative to each other to align the front face relative to the blade surface comprises positioning the front face parallel to the blade surface.

65. The method of claim 49, wherein causing the chuck or the blade to move relative to each other to align the front face relative to the blade surface comprises shaving one or more protrusions from the front face to smooth the front face.

66. The method of claim 49, wherein causing the chuck or the blade to move relative to each other to align the front face relative to the blade surface comprises:
shaving one or more protrusions from the front face to smooth the front face; and
positioning the front face parallel to the blade surface.

67. The method of claim 49, wherein identifying, from the sensed data, the alignment of the front face with respect to the blade surface comprises determining whether the alignment exceeds a pre-determined threshold value or is outside of a nominal range.

68. The method of claim 49, further comprising outputting, by the controller, an alert to a user to manually correct the alignment of the front face relative to the blade surface.

69. A method comprising:
receiving, by a controller, data sensed with at least one sensor, wherein the data relates to an alignment of a front face of a sample block received in a chuck and a blade surface of a blade configured to remove a tissue section from the sample block;
identifying, by the controller and from the data, a geometry of the front face;
identifying, by the controller and based on the geometry, the alignment of the front face with respect to the blade surface of the blade; and
causing the chuck or the blade to move relative to each other to align the front face relative to the blade surface.

70. The method of claim 69, further comprising causing, by the controller, the chuck or the blade to move relative to each other to section the sample block.

71. The method of claim 69, further comprising causing, by the controller, the chuck or the blade to move relative to each other to section the sample block after aligning the front face relative to the blade surface.

72. The method of claim 69, wherein identifying the geometry comprises identifying, from the data, an orientation of the front face relative to the blade surface.

73. The method of claim 69, wherein identifying the geometry comprises identifying, from the data, a topography of the front face.

74. The method of claim 69, wherein identifying the geometry comprises:
identifying, from the data, an orientation of the front face relative to the blade surface; and
identifying, from the data, a topography of the front face.

75. The method of claim 69, wherein causing the chuck or the blade to move relative to each other to align the front face relative to the blade surface comprises positioning the front face parallel to the blade surface.

76. The method of claim 69, wherein causing the chuck or the blade to move relative to each other to align the front face relative to the blade surface comprises shaving one or more protrusions from the front face to smooth the front face.

77. The method of claim 69, wherein causing the chuck or the blade to move relative to each other to align the front face relative to the blade surface comprises:
shaving one or more protrusions from the front face to smooth the front face; and
positioning the front face parallel to the blade surface.

78. The method of claim 69, wherein identifying, from the data, the alignment of the front face with respect to the blade surface comprises determining whether the alignment exceeds a pre-determined threshold value or is outside of a nominal range.

79. The method of claim 69, further comprising outputting, by the controller, an alert to a user to manually correct the alignment of the front face relative to the blade surface.
